(19) United States
(12) Patent Application Publication
(10) Pub. No.: US 2014/0324469 A1
(43) Pub. Date: Oct. 30, 2014

(54) CUSTOMIZABLE CONTEXT AND USER-SPECIFIC PATIENT REFERENCEABLE MEDICAL DATABASE

(71) Applicant: Bruce REINER, Berlin, MD (US)

(72) Inventor: Bruce REINER, Berlin, MD (US)

(21) Appl. No.: 14/265,941

(22) Filed: Apr. 30, 2014

Related U.S. Application Data
(60) Provisional application No. 61/817,634, filed on Apr. 30, 2013.

(51) Int. Cl. G06F 19/00; G06F 17/30

(52) U.S. Cl. CPC G06F 19/322; G06F 17/30589; G06F 17/30554
USPC 705/3

(57) ABSTRACT

The present invention is related to a patient-specific referenceable database which can record and track medical data throughout the healthcare and provider networks, be customized to the individual needs and preferences of healthcare providers, and adapted to the specific context being performed. The computer-implemented method and a system includes: saving data in a data hierarchy, including major data categories, in a database; wherein the data includes primary data representing various medical disciplines, and including all current and historical medical diagnoses and other data on a patient; retrieving and analyzing medical data from the database, in a data search in response to a search query, the medical data being specific to one of the medical disciplines related to one of the major data categories on the patient; and displaying the patient medical data on a display for user review in accordance with the user's electronic profile and preferences.

### CROSS-REFERENCE TO RELATED APPLICATIONS

The present application claims priority from U.S. Provisional Patent Application No. 61/817,634 filed Apr. 30, 2013, the contents of which are herein incorporated by reference in its entirety.

### BACKGROUND OF THE INVENTION

1. Field of the Invention

The present invention relates to a computer-implemented method and system which creates a patient-specific referenceable database which can record and track medical data throughout the healthcare continuum and provider network, and can be customized to the individual needs and preferences of healthcare providers, and adapted to the specific context being performed.

2. Description of the Related Art

Retrieval and extraction of medical data is a continuous challenge for healthcare professionals, largely due to the lack of data and technology integration, which forces manual and time intensive workflow. As productivity and workflow demands continue to increase, this relative lack of data accessibility and integration often results in valuable data often going unseen (i.e., the proverbial “tree in the woods”). The data exists, but its relative lack of availability renders it inconsequential. This has the potential to result in data redundancy through healthcare providers duplicating medical tests and studies which may not have been necessary had the full complement of medical data be readily available at the point of care. In addition, this relative lack of data can adversely affect healthcare outcomes when medical providers render diagnostic and treatment decisions in the absence of complete and definitive data. In addition to potentially introducing medical errors, inaccessible and incomplete medical data can lead to a number of more insidious outcomes which do not necessarily translate into full-blown medical errors, but nonetheless negatively impact clinical, operational, and economic efficiency. These can include time delays, diminished diagnostic confidence, excessive ordering of (unnecessary) consultations, and performance of interventional procedures which may have been obviated had the full complement of data been immediately available.

The current state of data inefficiency at the point of care is magnified by the fact that the volume and complexity of medical data is exponentially increasing. While computerized data mining applications offer a number of theoretical benefits related to enhanced data comprehension, they cannot in themselves fully operate without the full complement of available data. If key data elements are not available and included in the computerized data analysis, faulty or incomplete analytics will be derived. Simply stated, sophisticated computerized data mining is only as good as the quality and completeness of the input data. This maxim also holds true for conventional “human” medical data mining, where a healthcare professional's clinical experience, education, and knowledge cannot overcome deficient and/or inaccurate data (i.e., garbage in, garbage out). While a number of ongoing efforts are currently underway to create comprehensive and fully integrated patient electronic medical records and data repositories, the end result is incomplete due to a number of factors including (but not limited to) the proprietary nature of technology in use, incomplete tracking of patient data across multiple providers, lack of adaptability to the individual end-user needs, and lack of data integration across disparate medical information systems.

The concerns recited above are particularly difficult in a medical imaging practice due to its relative importance and customary use throughout numerous medical disciplines, its use of multi-faceted data (pictorial, graphical, numerical, and textual), and distribution of data across multiple information system technologies (e.g., radiology information system (RIS), picture archival and communication system (PACS), electronic medical record (EMR), computerized physician order entry system (CPOE), and digital reporting systems). For example, the method for patient-specific data collection that has historically been in use in film-based (i.e., analog) operation, has since been replaced with digital practice. In the conversion from analog to digital medical imaging practice, the routine use of these patient data collection instruments has largely dissipated to the detriment of patient care. On occasions where medical imaging providers still utilize these data collection instruments, the data primarily remains analog, and is recorded in analog format which is customarily discarded after short-term use. As a result, there is effectively no long-term, continuous, method for recording and tracking patient-specific data in routine operation. Each time the same patient presents to the medical imaging provider, a “new” datasheet is created which effectively is a duplicate version of prior datasheets. This has the potentially undesired effects of recording incomplete and/or faulty data, while adversely affecting workflow and productivity. By creating a standardized method for recording, tracking, and analyzing patient-specific data in a universal digital format, many of the existing data challenges and pitfalls can in theory be overcome.

Still further, the extraction of historical imaging and report data in conventional practice is largely manual; with radiologists, technologists, and clinicians tasked with manually opening up prior radiology reports in order to access pertinent historical imaging data. In the event that direct correlation with the prior imaging dataset is required, the end-user would be required to manually open the imaging dataset, identify the image(s) of interest, and correlate the imaging and report data. While this process is relatively simple and straightforward for a general radiography exam consisting of 1-4 images, it becomes problematic and time consuming for a cross-sectional imaging dataset (e.g., computed tomography (CT), magnetic resonance imaging (MRI)) which often includes multiple series and image counts in the hundreds (or even thousands). In the absence of direct linkage between text report and imaging data, this disassociation of data serves as a disincentive to comprehensive review of historical data, and as a result only small subcomponents of data are routinely reviewed.

If this lack of data integration is not troubling enough, historical imaging data review is further compromised by the fact that data is largely hidden, and requires the individual end-user to manually open up individual imaging datasets and/or reports with little knowledge as to the relative value and individual findings contained within these historical imaging datasets and reports. Conventional workflow and practice attempts to work around these deficiencies by selecting the most recent “comparable” chronologic imaging study, which is often defined by the type of imaging modality and anatomy reviewed. The problem with this approach however, is that important and relevant imaging data may lay in other historical imaging data and/or reports, which go undetected by this approach. For example, a lung nodule detected on an abdominal CT three years earlier may be easily overlooked due to the fact that it is customarily ignored when reviewing comparable imaging data for a current chest CT exam. In the event that the interpreting radiologist detected the same lung nodule on the current CT exam and erroneously identified this as a new and/or suspicious finding, the radiologist may recommend that the nodule be subjected to additional imaging (e.g., PET scan) or biopsy; resulting in additional expense, patient anxiety, and potential iatrogenic complications (e.g., pneumothorax).

In other concerns, the availability of clinical data at the time of medical image review and interpretation is largely limited to a few nonspecific words entered with the imaging exam order entry. This customarily takes the form of a generic symptom (e.g., pain, weakness), sign (e.g., fever, weight loss), or command (e.g., follow-up, assess change). In some cases, the clinical data entered does not even apply to the patient of record, but has been entered to simply satisfy and order entry requirement of the technology (e.g., RIS, CPOE). The net result is the radiologist tasked with interpretation of the imaging dataset has two basic options: either read the exam in a relative vacuum of clinical information, or manually search the patient's medical record to gain additional information. Unfortunately this latter option is often not practical, due to time constraints, lack of technology integration, and bourgeoning workloads. The net result is that the imaging interpretation and report generated in the absence of definitive clinical data is often incomplete, indecisive, or even incorrect. Something as simple as knowledge of an elevated white blood cell count, may change the diagnosis of airspace disease on a chest radiograph from pulmonary edema to pneumonia.

The net result is that the accuracy, definitiveness, clarity, and completeness of radiology reports is currently handicapped by the current technology and workflow related to historical imaging and clinical data retrieval.

Thus, what is needed to ameliorate these deficiencies is a computer-implemented method and system, to create a patient-specific referenceable database which can record and track medical data throughout the healthcare continuum and provider network, be customized to the individual needs and preferences of healthcare providers, and adapted to the specific context being performed. Further, the desired computer-implemented method and system would automate context specific data retrieval in a manner consistent with each individual end-user's preferences and workflow patterns. At the same time, a unified approach targeting both imaging and clinical data would be of greatest value, since both forms of data retrieval are currently lacking and equally important in diagnosis, treatment, and disease surveillance.

### SUMMARY OF THE INVENTION

The present invention relates to a computer-implemented method and system, to create a patient-specific referenceable database which can record and track medical data throughout the healthcare continuum and provider network, be customized to the individual needs and preferences of healthcare providers, and adapted to the specific context being performed. The present invention is designed to function for all medical disciplines and all types of healthcare stakeholders (including both providers and consumers of healthcare services). In exemplary embodiments, the present invention is particularly described with respect to a medical imaging practice.

The computer-implemented method and system of the present invention includes a computer program which can rapidly search, query, and retrieve data from a patient-specific database, based upon individual findings contained within the imaging datasets and reports, while providing this data quickly and efficiently to the end-user based without the need for manual input and multi-step commands. The automated data search and retrieval functions of the present invention, would ideally provide the end-user with both imaging and clinical report data in a single collective process. Further, the method and system of the present invention would automate context specific data retrieval in a manner consistent with each individual end-user's preferences and workflow patterns.

One way to accomplish this task would be for the program to capture finding-specific “key images” for all individual report findings, which in turn can be archived by the program in a finding-specific database. In such a manner, the above-described example of a “new” finding of lung nodule on chest CT could automatically generate a query by the program of the historical imaging database, which would identify the historical finding of lung nodule on the prior abdominal CT performed three years earlier. When the radiologist reviewed the retrieved report/imaging data specific to this finding, he/she would be able to determine if the current and historical findings were relevant to one another and if so, be able to accurately and definitively determine temporal change. Further, with the program “linking” the historical and current “key images” to one another and incorporating them into the current report, the clinician is able to gain greater insight into the imaging finding of interest, its clinical significance, and diagnosis.

Thus, in one embodiment, a computer-implemented method of recording and tracking medical data, includes: saving data in a data hierarchy, including major data categories, in a database; wherein said data includes primary data, representing various medical disciplines, including all current and historical medical diagnoses and other data on a patient; retrieving and analyzing medical data from said database, using a processor, in a data search in response to a search query, said medical data being specific to one of said medical disciplines related to one of said major data categories on said patient; and displaying said medical data on said patient on a display for user review in accordance with said user's electronic profile and preferences.

In one embodiment, history and physical data is a primary data category, and one of sub-categories or all relevant data under said history and physical primary data category, can be retrieved from said database.

In yet another embodiment, the method includes saving results of each search query in said database.

In yet another embodiment, the method includes incorporating results of said data search from each said search query, using said processor, into a future data search protocols to provide pre-populated data search protocols to said user.

In yet another embodiment, the data search protocols can be modified.

In yet another embodiment, the method includes importing data search protocols between users, using said processor.

In yet another embodiment, the method includes utilizing artificial intelligence inferencing, using said processor, to determine additional data elements to include in each said data search.

In yet another embodiment, the method includes integrating electronic data tracking tools using said processor, into said data search, to monitor and analyze methods of accessing, viewing, and acting upon said data; and utilizing statistical methods and artificial intelligence techniques, using said processor, to identify similarities for predicting future use.

In yet another embodiment, the electronic data tracking tools include electronic auditing tools and/or eye tracking software.

In yet another embodiment, the method includes creating automated data presentation and workflow templates, using said processor, based upon analysis of results of said electronic tracking tools.

In yet another embodiment, the method includes prioritizing or ignoring data for saving in said database, using said processor, and/or identifying priority or actionable data for including in said database.

In yet another embodiment, the method includes utilizing data triggers, using said processor, to search, characterize, and select priority or actionable data for inclusion in said database; wherein said data triggers include at least one of clinical significance, follow-up recommendations, quality assurance events, temporal change, medical or surgical intervention, critical results communication, medical referral or consultation, hospitalization or medical transfer, new or altered medical diagnosis, new or altered medical treatment, or a custom data trigger predetermined by an institutional or individual service provider.

In yet another embodiment, the method includes verifying data using a secondary party, using said processor, before inclusion of said data in said database.

In yet another embodiment, the method includes determining an accuracy of said data being utilized from said data search, using said processor, by validating, refuting, or modifying said data, to provide quality assurance on said data; and recording at least one of an identity of said source of said data, an editing source, supporting data, or date/time of data transaction, in said database.

In yet another embodiment, the method includes categorizing, using said processor, a quality assurance deficiency with said data and any actions taken; and providing an automated feedback function, using said processor, to notify said source of said data when said data has said quality assurance deficiency, and to provide said source with results of further data analysis.

In yet another embodiment, the method includes performing data analytics, using said processor, to provide users with statistical data regarding a relative reliability and accuracy of various data sources, to determine which sources are to be used in an automated data search.

In yet another embodiment, the method includes implementing data sensitivity filters, using said processor, such that a desired level of data granularity is achieved in said data search.

In yet another embodiment, the method includes automatically retrieving from said database, and reviewing, using said processor, data search and presentation templates of other users.

In yet another embodiment, a non-transitory computer-readable medium containing executable code for recording and tracking medical data, includes: saving data in a data hierarchy, including major data categories, in a database; wherein said data includes primary data, representing various medical disciplines, including all current and historical medical diagnoses and other data on a patient; retrieving and analyzing medical data from said database, using a processor, in a data search in response to a search query, said medical data being specific to one of said medical disciplines related to one of said major data categories on said patient; and displaying said patient data on a display for user review in accordance with said user's electronic profile and preferences.

In yet another embodiment, a computer system which records and tracks medical data, includes: at least one memory which contains at least one program which includes the steps of: saving data in a data hierarchy, including major data categories, in a database; wherein said data includes primary data, representing various medical disciplines, including all current and historical medical diagnoses and other data on a patient; retrieving and analyzing medical data from said database, using a processor, in a data search in response to a search query, said medical data being specific to one of said medical disciplines related to one of said major data categories on said patient; and displaying said patient data on a display for user review in accordance with said user's electronic profile and preferences; and at least one processor for executing the program.

Thus has been outlined, some features consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWINGS

FIG. 1 is a schematic diagram of a system for recording and tracking medical data over a network, according to one embodiment consistent with the present invention.

FIG. 2 is a chart showing a chronologic display of hypertension medications for a patient, according to one embodiment consistent with the present invention.

FIG. 3 is chart showing a chronologic display of hypertension medications and systolic blood pressure measurements over three years, for a patient, according to one embodiment consistent with the present invention.

FIG. 4 is a chart showing a chronologic display of laboratory data related to hypertensive medications over three years, for a patient, according to one embodiment consistent with the present invention.

FIG. 5 is a chart showing a chronologic display of medications and laboratory data related to hypertensive medications over three years, for a patient, according to one embodiment consistent with the present invention.

FIG. 6 is a customized data display for a patient having cough symptoms, according to one embodiment consistent with the present invention.

FIG. 7 is a diagram showing data requirements for Radiologist A in chest CT interpretation, according to one embodiment consistent with the present invention.

FIG. 8 is a diagram showing data requirements for Radiologist B in chest CT interpretation, according to one embodiment consistent with the present invention.

FIG. 9 is a diagram showing continued data requirements for Radiologist B in chest CT interpretation, according to one embodiment consistent with the present invention.

FIG. 10 is a diagram showing data requirements for Radiologist C in chest CT interpretation, according to one embodiment consistent with the present invention.

### DESCRIPTION OF THE INVENTION

The present invention relates to a computer-implemented method and system, to create a patient-specific referenceable database which can record and track medical data throughout the healthcare continuum and provider network, be customized to the individual needs and preferences of healthcare providers, and adapted to the specific context being performed.

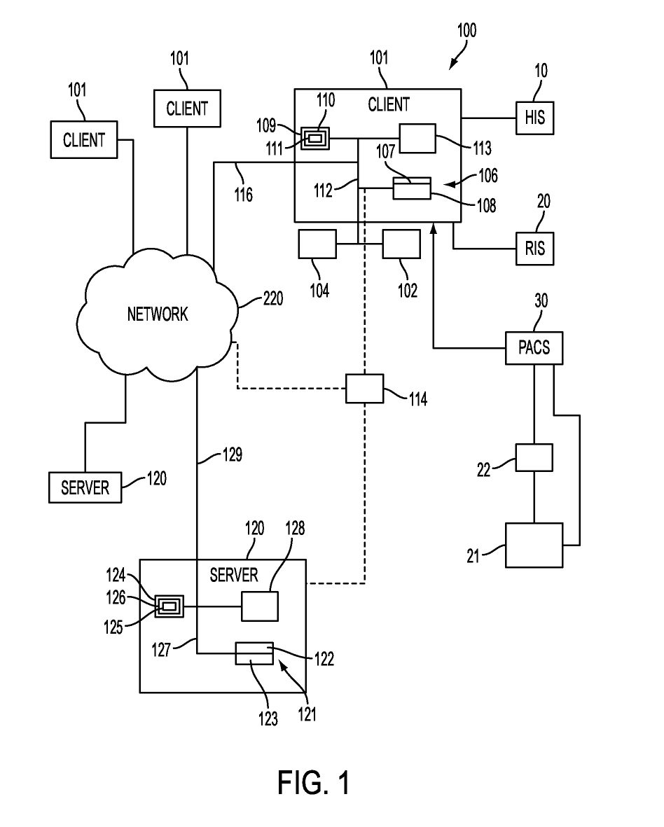

According to one embodiment of the invention illustrated in FIG. 1, medical (radiological) applications may be implemented using the system 100. The system 100 is designed to interface with existing information systems such as a Hospital Information System (HIS) 10, a Radiology Information System (RIS) 20, a radiographic device 21, and/or other information systems that may access a computed radiography (CR) cassette or direct radiography (DR) system, a CR/DR plate reader 22, a Picture Archiving and Communication System (PACS) 30, and/or other systems. The system 100 may be designed to conform with the relevant standards, such as the Digital Imaging and Communications in Medicine (DICOM) standard, DICOM Structured Reporting (SR) standard, and/or the Radiological Society of North America's Integrating the Healthcare Enterprise (IHE) initiative, among other standards.

According to one embodiment, bi-directional communication between the system 100 of the present invention and the information systems, such as the HIS 10, RIS 20, radiographic device 21, CR/DR plate reader 22, and PACS 30, etc., may be enabled to allow the system 100 to retrieve and/or provide information from/to these systems. According to one embodiment of the invention, bi-directional communication between the system 100 of the present invention and the information systems allows the system 100 to update information that is stored on the information systems. According to one embodiment of the invention, bi-directional communication between the system 100 of the present invention and the information systems allows the system 100 to generate desired reports and/or other information.

The system 100 of the present invention includes a client computer 101, such as a personal computer (PC), which may or may not be interfaced or integrated with the PACS 30. The client computer 101 may include an imaging display device 102 that is capable of providing high resolution digital images in 2-D or 3-D, for example. According to one embodiment of the invention, the client computer 101 may be a mobile terminal if the image resolution is sufficiently high. Mobile terminals may include mobile computing devices, a mobile data organizer (PDA), or other mobile terminals that are operated by the user accessing the program 110 remotely.

According to one embodiment of the invention, an input device 104 or other selection device, may be provided to select hot clickable icons, selection buttons, and/or other selectors that may be displayed in a user interface using a menu, a dialog box, a roll-down window, or other user interface. The user interface may be displayed on the client computer 101. According to one embodiment of the invention, users may input commands to a user interface through a programmable stylus, keyboard, mouse, speech processing device, laser pointer, touch screen, or other input device 104.

According to one embodiment of the invention, the input or other selection device 104 may be implemented by a dedicated piece of hardware or its functions may be executed by code instructions that are executed on the client processor 106. For example, the input or other selection device 104 may be implemented using the imaging display device 102 to display the selection window with a stylus or keyboard for entering a selection.

According to another embodiment of the invention, symbols and/or icons may be entered and/or selected using an input device 104, such as a multi-functional programmable stylus. The multi-functional programmable stylus may be used to draw symbols onto the image and may be used to accomplish other tasks that are intrinsic to the image display, navigation, interpretation, and reporting processes, as described in U.S. patent application Ser. No. 11/512,199 filed on Aug. 30, 2006, the entire contents of which are hereby incorporated by reference. The multi-functional programmable stylus may provide superior functionality compared to traditional computer keyboard or mouse input devices. According to one embodiment of the invention, the multi-functional programmable stylus also may provide superior functionality within the PACS and Electronic Medical Report (EMR).

According to one embodiment of the invention, the client computer 101 may include a processor 106 that provides client data processing. According to one embodiment of the invention, the processor 106 may include a central processing unit (CPU) 107, a parallel processor, an input/output (I/O) interface 108, a memory 109 with a program 110 having a data structure 111, and/or other components. According to one embodiment of the invention, the components all may be connected by a bus 112. Further, the client computer 101 may include the input device 104, the image display device 102, and one or more secondary storage devices 113. According to one embodiment of the invention, the bus 112 may be internal to the client computer 101 and may include an adapter that enables interfacing with a keyboard or other input device 104. Alternatively, the bus 112 may be located external to the client computer 101.

According to one embodiment of the invention, the image display device 102 may be a high resolution touch screen computer monitor. According to one embodiment of the invention, the image display device 102 may clearly, easily and accurately display images, such as x-rays, and/or other images. Alternatively, the image display device 102 may be implemented using other touch sensitive devices including tablet personal computers, pocket personal computers, plasma screens, among other touch sensitive devices. The touch sensitive devices may include a pressure sensitive screen that is responsive to input from the input device 104, such as a stylus, that may be used to write/draw directly onto the image display device 102.

According to another embodiment of the invention, high resolution goggles may be used as a graphical display to provide end users with the ability to review images. According to another embodiment of the invention, the high resolution goggles may provide graphical display without imposing physical constraints of an external computer.

According to another embodiment, the invention may be implemented by an application that resides on the client computer 101, wherein the client application may be written to run on existing computer operating systems. Users may interact with the application through a graphical user interface. The client application may be ported to other personal computer (PC) software, personal digital assistants (PDAs), cell phones, and/or any other digital device that includes a graphical user interface and appropriate storage capability.

According to one embodiment of the invention, the processor 106 may be internal or external to the client computer 101. According to one embodiment of the invention, the processor 106 may execute a program 110 that is configured to perform predetermined operations. According to one embodiment of the invention, the processor 106 may access the memory 109 in which may be stored at least one sequence of code instructions that may include the program 110 and the data structure 111 for performing predetermined operations. The memory 109 and the program 110 may be located within the client computer 101 or external thereto.

While the system of the present invention may be described as performing certain functions, one of ordinary skill in the art will readily understand that the program 110 may perform the function rather than the entity of the system itself.

According to one embodiment of the invention, the program 110 that runs the system 100 may include separate programs 110 having code that performs desired operations. According to one embodiment of the invention, the program 110 that runs the system 100 may include a plurality of modules that perform sub-operations of an operation, or may be part of a single module of a larger program 110 that provides the operation.

According to one embodiment of the invention, the processor 106 may be adapted to access and/or execute a plurality of programs 110 that correspond to a plurality of operations. Operations rendered by the program 110 may include, for example, supporting the user interface, providing communication capabilities, performing data mining functions, performing e-mail operations, and/or performing other operations.

According to one embodiment of the invention, the data structure 111 may include a plurality of entries. According to one embodiment of the invention, each entry may include at least a first storage area, or header, that stores the databases or libraries of the image files, for example.

According to one embodiment of the invention, the storage device 113 may store at least one data file, such as image files, text files, data files, audio files, video files, among other file types. According to one embodiment of the invention, the data storage device 113 may include a database, such as a centralized database and/or a distributed database that are connected via a network. According to one embodiment of the invention, the databases may be computer searchable databases. According to one embodiment of the invention, the databases may be relational databases. The data storage device 113 may be coupled to the server 120 and/or the client computer 101, either directly or indirectly through a communication network, such as a Local Area Network (LAN), Wide Area Network (WAN), and/or other networks. The data storage device 113 may be an internal storage device. According to one embodiment of the invention, system 100 may include an external storage device 114. According to one embodiment of the invention, data may be received via a network and directly processed.

According to one embodiment of the invention, the client computer 101 may be coupled to other client computers 101 or servers 120. According to one embodiment of the invention, the client computer 101 may access administration systems, billing systems and/or other systems, via a communication link 116. According to one embodiment of the invention, the communication link 116 may include a wired and/or wireless communication link, a switched circuit communication link, or may include a network of data processing devices such as a LAN, WAN, the Internet, or combinations thereof. According to one embodiment of the invention, the communication link 116 may couple e-mail systems, fax systems, telephone systems, wireless communications systems such as pagers and cell phones, wireless personal data assistants(PDA)'s and other communication systems.

According to one embodiment of the invention, the communication link 116 may be an adapter unit that is capable of executing various communication protocols in order to establish and maintain communication with the server 120, for example. According to one embodiment of the invention, the communication link 116 may be implemented using a specialized piece of hardware or may be implemented using a general CPU that executes instructions from program 110. According to one embodiment of the invention, the communication link 116 may be at least partially included in the processor 106 that executes instructions from program 110.

According to one embodiment of the invention, if the server 120 is provided in a centralized environment, the server 120 may include a processor 121 having a CPU 122 or parallel processor, which may be a server data processing device and an I/O interface 123. Alternatively, a distributed CPU 122 may be provided that includes a plurality of individual processors 121, which may be located on one or more machines. According to one embodiment of the invention, the processor 121 may be a general data processing unit and may include a data processing unit with large resources (i.e., high processing capabilities and a large memory for storing large amounts of data).

According to one embodiment of the invention, the server 120 also may include a memory 124 having a program 125 that includes a data structure 126, wherein the memory 124 and the associated components all may be connected through bus 127. If the server 120 is implemented by a distributed system, the bus 127 or similar connection line may be implemented using external connections. The server processor 121 may have access to a storage device 128 for storing preferably large numbers of programs 110 for providing various operations to the users.

According to one embodiment of the invention, the data structure 126 may include a plurality of entries, wherein the entries include at least a first storage area that stores image files. Alternatively, the data structure 126 may include entries that are associated with other stored information as one of ordinary skill in the art would appreciate.

According to one embodiment of the invention, the server 120 may include a single unit or may include a distributed system having a plurality of servers 120 or data processing units. The server(s) 120 may be shared by multiple users in direct or indirect connection to each other. The server(s) 120 may be coupled to a communication link 129 that is preferably adapted to communicate with a plurality of client computers 101.

According to one embodiment, the present invention may be implemented using software applications that reside in a client and/or server environment. According to another embodiment, the present invention may be implemented using software applications that reside in a distributed system over a computerized network and across a number of client computer systems. Thus, in the present invention, a particular operation may be performed either at the client computer 101, the server 120, or both.

According to one embodiment of the invention, in a client-server environment, at least one client and at least one server are each coupled to a network 220, such as a LAN, WAN, and/or the Internet, over a communication link 116, 129. Further, even though the systems corresponding to the HIS 10, the RIS 20, the radiographic device 21, the CR/DR reader 22, and the PACS 30 (if separate) are shown as directly coupled to the client computer 101, it is known that these systems may be indirectly coupled to the client over a LAN, WAN, the Internet, and/or other network via communication links. According to one embodiment of the invention, users may access the various information sources through secure and/or non-secure internet connectivity. Thus, operations consistent with the present invention may be carried out at the client computer 101, at the server 120, or both. The server 120, if used, may be accessible by the client computer 101 over the Internet, for example, using a browser application or other interface.

According to one embodiment of the invention, the client computer 101 may enable communications via a wireless service connection. The server 120 may include communications with network/security features, via a wireless server, which connects to, for example, voice recognition. According to one embodiment, user interfaces may be provided that support several interfaces including display screens, voice recognition systems, speakers, microphones, input buttons, and/or other interfaces. According to one embodiment of the invention, select functions may be implemented through the client computer 101 by positioning the input device 104 over selected icons. According to another embodiment of the invention, select functions may be implemented through the client computer 101 using a voice recognition system to enable hands-free operation. One of ordinary skill in the art will recognize that other user interfaces may be provided.

According to another embodiment of the invention, the client computer 101 may be a basic system and the server 120 may include all of the components that are necessary to support the software platform. Further, the present client-server system may be arranged such that the client computer 101 may operate independently of the server 120, but the server 120 may be optionally connected. In the former situation, additional modules may be connected to the client computer 101. In another embodiment consistent with the present invention, the client computer 101 and server 120 may be disposed in one system, rather being separated into two systems.

Although the above physical architecture has been described as client-side or server-side components, one of ordinary skill in the art will appreciate that the components of the physical architecture may be located in either client or server, or in a distributed environment. Further, although the above-described features and processing operations may be realized by dedicated hardware, or may be realized as programs having code instructions that are executed on data processing units, it is further possible that parts of the above sequence of operations may be carried out in hardware, whereas other of the above processing operations may be carried out using software.

The underlying technology allows for replication to various other sites. Each new site may maintain communication with its neighbors so that in the event of a catastrophic failure, one or more servers 120 may continue to keep the applications running, and allow the system to load-balance the application geographically as required.

Further, although aspects of one implementation of the invention are described as being stored in memory, one of ordinary skill in the art will appreciate that all or part of the invention may be stored on or read from other computer-readable media, such as secondary storage devices, like hard disks, floppy disks, CD-ROM, a carrier wave received from a network such as the Internet, or other forms of ROM or RAM either currently known or later developed. Further, although specific components of the system have been described, one skilled in the art will appreciate that the system suitable for use with the methods and systems of the present invention may contain additional or different components.

The present invention relates to a computer-implemented method and system, to create a patient-specific referenceable database which can record and track medical data throughout the healthcare continuum and provider network, be customized to the individual needs and preferences of healthcare providers, and adapted to the specific context being performed.

In one embodiment, the Data Search Protocol application of the present invention includes the following data classification and categorization schema, on which the program 110 collects inputted data, and stores this data to the referenceable database 113.

At the highest level there are four major data categories: 1) Pathology (pathologic finding/disease or diagnosis); 2) Test (procedure, exam, or technology); 3) Presentation (clinical sign and/or symptom); and 4) Anatomy (anatomic structure or organ system).

In one embodiment, at the next level of data hierarchy is Primary Data, which represent the various medical disciplines, along with the Medical Problem List which summarizes all current and historical medical diagnoses and problems in the health care continuum of a given patient. Primary data categories include: 1) Imaging; 2) Laboratory; 3) Pathology; 4) Genetics; 5) Pharmacology; 6) Surgery (and sub-specialties); 7) Internal Medicine (and sub-specialties); 8) Pediatrics (and sub-specialties); 9) Medical Problem List; and 10) Procedures and Tests.

The Primary Data provides the end-user with the ability to retrieve and analyze medical data specific to a certain medical discipline (e.g., Pharmacology), relating to a pre-defined Major Data category. As an example, if the end-user wants to review a patient's medical data related to a given diagnosis (e.g., hypertension), the end-user would input the disease under the Major Data Category of “Pathology” into the computer as a query. If no additional data retrieval specifications are inputted by the user, then all patient-specific data related to Hypertension would be retrieved and presented by the program 110 for user review on the display 102, in keeping with the individual end-user's profile and preferences. If, on the other hand, the end-user selects a specific Primary Data Category (i.e., Pharmacology), then only data specific to that primary data category would be retrieved and presented for review by the program 110. In this example, (i.e., Major Data Category: hypertension, Primary Data Category: Pharmacology), the database 113 would be queried by the program 110 and only pharmacologic data specific to the diagnosis of hypertension would be retrieved. (Note that in addition to text format, the program 110 can alternatively display these data categories using icons and symbols (e.g., X-ray for Imaging, DNA helix for Genetics, Mortar and Pestle for Pharmacology, etc.).

After inputting data relevant to the Major and Primary Data categories, the end-user has the option for specifying individual sub-categories under the History and Physical (H & P) data: 1) Physical exam; 2) Present illness; 3) Social history; 4) Family history; 5) Occupational history; 6) Environmental history; 7) Medications; 8) Allergies; and 9) Surgeries and procedures. In addition, secondary data categories can be chosen, which include: 1) Pictorial data; 2) Report data; 3) Safety data; 4) Technical data; 5) Administrative data; 6) Quality data; 7) Procedural data; and 8) Medication data.

If, for example, no sub-category is selected, the program 110 would automatically retrieve from the database 113, all relevant H & P data related to hypertension (e.g., physical exam data (e.g., blood pressure measurements), family history data (e.g., family members with diagnoses hypertension), social history (e.g. alcohol use), and occupational history (e.g., job-related stress)).

Alternatively, in one embodiment, the end-user can selectively input “Physical Exam” data as a query, and the program 110 would retrieve only those physical exam data related to hypertension and ignore additional H & P sub-categorical data. It is important to note that the selection of these data search criteria can be manual, automated, or semi-automated. In the manual mode of operation, the end-user simply selects the data category and data element of interest. As an example, if one wants to search for data under the Major Data category of Anatomy, the user can simply select the organ system of interest from the user interface or select the anatomic region of interest from the anatomic graphical image, for example, on the display 102.

In the automated mode (embodiment) of operation, search data elements are automatically selected by the program 110 based upon pre-defined rules, which are context and user-specific.

As an example, if the end-user is a cardiologist who is presented with an electrocardiogram (EKG) for interpretation with the accompanying order stating the clinical history of acute chest pain, then the following search categories will be automatically selected by the program 110 based upon pre-defined rules (established either by the individual and/or community of end-users) or artificial intelligence techniques (e.g., neural networks):

Major Data Category: 1) Anatomy: organ system: Cardiovascular; 2) Presentation: Acute chest pain; 3) Test: EKG.

Based upon these search criteria, all relevant data from the patient's medical database 113 would be retrieved and made available for review by the program 110. Alternatively, if the cardiologist was only interested in EKG data, he/she could do so by individually selecting “Test: EKG only” as the query. This would effectively restrict the data search by the program 110 only to EKG data (under the Major Category: Test), and exclude additional data contained within the Primary, Secondary, and H& P data categories. This process modifies the pre-defined (i.e. automated) data search protocol (i.e., is “semi-automated”).

In one embodiment, in all cases, the end-user can “save” a query into the database 113 using the program 113, and incorporate the results into his/her pre-defined (i.e., automated) data search protocols for future use, using the program 110. In this example, the cardiologist may opt to categorize the search as “Test: EKG only”. The comprehensive list of automated search protocols can be presented by the program 110 to each end-user at the time each new patient's medical database 113 is opened. As new input data is introduced by the user, the corresponding list of relevant search protocols is presented by the program 110 for user review, thereby providing the end-user with a relevant list of user and context-specific search protocols. This provides each end-user with pre-populated data search protocols, along with the ability to modify/edit these search protocols at any time. In addition, search data protocols can be imported between different end-users by deselecting the “Importation” feature of the Data Search Protocol application of the present invention. This provides an efficient method of expanding the use of automated data search, while maintaining the ability to customize these search protocols “on the fly”. As search protocols expand in number and complexity, the infrastructure is created by the program 110 for creation of automated data workflow templates, which will be described in detail below.

In one embodiment, the semi-automated mode of data search can also have the program 110 utilize artificial intelligence “inferencing” to determine which additional data elements are likely to be incorporated into the data search, based upon more limited pre-defined data. As an example, if a vascular surgeon is asked to consult on a patient with transient ischemia attacks (TIAs), the pre-defined Major Search data is Presentation: TIA, which falls under the category of Presentation (Signs and Symptoms). Using inferencing and the profile status of the end-user (i.e., vascular surgeon), additional categorical data is inferred by the program 110 which include the following:
1. Anatomy: Organ System: Cardiovascular (Carotid Artery)
2. Tests/Procedures: Carotid Artery Stent, Brain Imaging (CT and MRI), Carotid Artery Imaging (Ultrasound and Angiography)
3. Surgery: Vascular Surgery, Carotid Endarterectomy
4. Pharmacology: Anticoagulation and Thrombolytic Medications

In one embodiment, once these additional search categories are presented (through inferencing), the end-user is presented with options by the program 110, such as: “Accept”, “Delete” or “Modify”. By accepting, the additional data search categories are incorporated by the program 110 into the data search and presentation. If deleted, all additional search categories are deleted by the program 110 and the search is limited to the original search data (i.e., prior to inferencing). If the “Modify” option is selected, the end-user can manually edit the additional search items as to what is added and what is deleted from the original program 110 search.

In one embodiment, once the Major Data Categories have been defined, the specific Primary Data Categories of interest are selected by the user, which reflect the various medical disciplines in which the data is classified (e.g., Imaging, Laboratory, Genetic, etc.). As previously stated, the selection of Primary Data Categories can be done using either manual or automated methods. Automated Primary Data Category selection by the program 110 is largely context and user-specific, and takes advantage of the fact that data retrieval and analysis by the program 110 is largely predictable based upon the task being performed (i.e., context), profile of the end-user, and historical usage (i.e., predictive analytics). This illustrates an important component of the present invention, which is the direct integration into the program 110 of electronic data tracking tools to monitor and analyze the various ways data is accessed, viewed, and acted upon, and using statistical methods and artificial intelligence techniques to identify similarities for predicting future use. The electronic tracking tools used for this analysis may include electronic auditing tools which capture input commands (e.g., key strokes, mouse clicks) and/or eye tracking software which tracks eye movement and gaze characteristics. By the program 110 tracking these data, one can effectively learn the specific type, sequence, and analysis of data based upon the specific task being performed and characteristics of the individual end-user. The natural progression of using these predictive analytics for automated selection of Primary Data Categories would be the eventual creation of automated data presentation and workflow templates by the program 110. These would effectively provide the individual end-user with the option of having the program 110 automatically select the specific types of data for retrieval, the optimal manner in which the data is presented to the user on the display 102 for review, the sequence and timing of data progression, and the resulting data analytics performed by the program 110. These automated data templates would have the theoretical benefits of improving the consistency and completeness of data review, while also reducing operational demands (and resulting stress/fatigue) on the part of the end-user.

In one embodiment, a large number of data sources could be used for creation of the patient-specific clinical database 113 by the program 110, including a number of information system (IS) technologies including (but not limited to) the electronic medical record (EMR), hospital information system (HIS), departmental information systems (e.g., laboratory, pharmacy, pathology information systems), and billing systems. For example, Clinical Data Sources may include: History and physical (H & P), Hospital discharge summaries, Consultation reports, Clinical test results, Laboratory data, Pathology reports, Procedural/surgical notes, Physician and pharmacy orders, Disease problem lists, Progress and physician notes, and Billing systems.

In addition to the program 110 mining these primary data sources—which are largely physician-generated—a number of secondary data sources exist (e.g., consultation reports, status reports, progress notes, etc.), which are often generated by non-physician medical staff (i.e., technologists, therapists, nurses, dieticians), and patients (e.g., questionnaires, medical history forms).

Since these combined data sources can produce large volumes of data, in one embodiment, the program 110 could prioritize or ignore certain data for population to the patient referenceable database 113. One of the important features of the present invention, is that it creates “data economy”, where the program 110 effectively distills the collective data volume in a patient's comprehensive medical record down to a small and manageable data volume, which can be effectively viewed in a single source and within a relatively small time period, in order to promote workflow efficiency. The ability to sort through large volumes of medical data and identify “high priority” or actionable data for inclusion in the referenceable database 113, is a key feature of the program 110 of the present invention.

In one embodiment, the criteria (i.e., data triggers) used to search, characterize, and select these “high priority” or actionable data are: 1) Clinical Significance; 2) Follow-up Recommendations; 3) QA events; 4) Temporal Change; 5) Medical or Surgical Intervention; 6) Critical Results Communication; 7) Medical Referral or Consultation; 8) Hospitalization or Medical Transfer; 9) New or Altered Medical Diagnosis; and 10) New or Altered Medical Treatment.

The first of these data triggers for inclusion in the referenceable database 113 is Clinical Significance. When the clinical significance of a medical finding (e.g., test result, physical exam finding, symptom) is deemed to achieve a predefined threshold (e.g., high clinical significance), then the associated data would be automatically tagged by the program 110 for inclusion in the database 113. While the threshold for clinical significance inclusion can be modified by the program 110 in accordance with the clinical context or service provider (at both institutional and individual provider levels) requirements, data associated with high or emergent clinical significance would always be included by the program 110. The classification of clinical significance can be performed either manually (i.e., by an authorized clinical end-user) or through automated methods (e.g., computerized artificial intelligence and data mining techniques).

The second trigger is Follow-up Recommendations, which can be associated with test results (e.g., radiology reports), medical consultations, clinical evaluations (e.g., annual physical exam), or medical procedures. When a follow-up recommendation (e.g., imaging exam, clinical test, biopsy) is recorded in the database by the program 110, this would also serve as a trigger for inclusion in the patient referenceable database 113 by the program 110. Since the follow-up recommendation is specifically related to an initial data element, the association relationship between these data points would be reflected in the database 113 by the program 110, thereby providing data continuity over the course of the patient's medical record.

The next trigger for database 113 inclusion by the program 110 is Quality Assurance (QA) events, which are routinely related to some event associated with quality or safety deficiency. Examples of QA events would include an allergic reaction to medication, adverse clinical event related to a procedure (e.g., excessive bleeding), incorrect pharmaceutical administration (e.g., incorrect medication or improper dosage), or failure to provide treatment in a timely fashion.

Temporal Change is an important data trigger which constitutes both new and worsening medical data. If, for example, a new finding or abnormality is recorded in the patient's medical record (database), it would automatically trigger inclusion into the referenceable database 113 by the program 110. This could take a number of forms including (but not limited to) new or worsening measurements (e.g., blood pressure), test results (e.g., imaging exam, laboratory test), or clinical symptoms (e.g., rectal bleeding).

Any time a medical or surgical invention is initiated, this would constitute a trigger for the referenceable database 113 inclusion by the program 110. In a similar fashion, a new recorded medical referral or consultation would also serve as a data trigger, since this would reflect a substantive change in the patient's clinical state requiring more specialized clinical evaluation.

Critical results communications, by definition, involve high priority or actionable data and would, therefore, be included by the program 110 in the referenceable database 113. At the same time, new hospital admissions or medical transfers to alternative healthcare facilities would also warrant inclusion by the program 110 in the referenceable database 113, since they represent significant medical events in the overall continuum of the patient's health status.

In one embodiment, these data triggers can be supplemented by any number of additional data triggers determined by the institutional or individual service provider. Since the purpose of the referenceable database 113 is to provide a condensed version of the patient's record, specific to each individual provider's needs and preferences, the ability of the program 110 to incorporate customized data triggers facilitates this ability of the referenceable database 113 to be modified in accordance with the provider's practice patterns and data standards.

In one embodiment, when prospective data is identified for inclusion in the referenceable database 113, by the program 110, it may be required by the program 110 to undergo verification by a secondary party (i.e., human or software program 110) before it is formally recorded by the program 110 in the referenceable database 113. This optional verification step serves a number of functions, including (but not limited to): conformation that the data reaches (or does not reach) the desired threshold for inclusion, verification of the data source, validation of data integrity and accuracy, and data modification (if required).

In one embodiment, a feature of the program 110 is the determining of the accuracy of the data being utilized, and creating a mechanism to validate, refute, or modify data throughout the course of the patient care continuum. It is not uncommon for data to be recorded which turns out to be inaccurate or misleading (e.g., data entry error). In conventional practice, once erroneous data has been populated into the patient's medical record, it often goes undetected, frequently repeated, and may become an integral (although inaccurate) part of the patient's record, upon which faulty decisions and analyses can be made. In the current healthcare technology and database infrastructure, there is no easy and documentable method for editing and/or deleting inaccurate or questionable data.

However, in one embodiment, the program 110 of the present invention provides a mechanism to accomplish this task, while simultaneously recording the identity of the source/editing source, supporting data, date/time of the data transaction, and any subsequent actions or ill effects (e.g., communications, altered analyses, or clinical actions) in the referenceable database 113. By doing so, the program 110 creates a method for data quality assurance (QA), with the goals of improving data integrity, accuracy, and consistency. By the program 110 continuously recording and tracking all data sources, the program 110 can also provide valuable information related to the overall quality of different data sources. In the event that a specific data element was found to be erroneous (e.g., medication dosage, disease diagnosis, date of surgery, etc.), an automated feedback function would be initiated to notify the original source of the data in question and results of further analysis. The resulting data QA analysis by the program 110 could then categorize the QA deficiency on the basis of clinical impact (e.g., minor, moderate, severe) and present isolated and cumulative data QA analyses to a QA review committee within the medical institution, as well as storing the information in a centralized database 113 for future retrieval. Minor data QA discrepancies would be documented by the program 110 and require no additional action, assuming the responsible party does not exhibit a record of frequent data errors. Moderate discrepancies may require relatively minor action (e.g., requisite education/training regarding data documentation and verification) or short-term supervision/oversight. Major errors could result in more substantive action (depending upon the severity of the data error, perceived intent, and clinical outcomes), which could range from extended probation, suspension or loss of clinical privileges, or proctoring by a supervisory staff member.

In one embodiment, the data QA analytics by the program 110 could provide end-users with statistical data as to the relative reliability and accuracy of different data sources, which in turn could serve as a guide in determining which data sources are to be used in automated data search or extraction by the program 110. As an example, when an end-user (e.g., physician) is setting up automated data extraction/presentation protocols using the program 110, he/she may wish to review the data QA analytics of different data sources and place a directive as to which data sources are routinely used (or not used), or notification schema in the event that QA scores of a requested data source have recently changed or undergone heightened scrutiny. In addition to establishing automated templates provided by the program 110, QA feedback on respective data sources can also be routinely provided in manual operation. The end goal is to provide end-users with objective feedback and analysis regarding the accuracy, reliability and integrity of different data sources. Those data sources which consistently demonstrate the highest grades of data accuracy would therefore be recognized and used most frequently, while data sources of less reliability may be subject to greater scrutiny. As in any ongoing QA program, data sources would be continuously analyzed and updated by the program 110, with feedback provided to users in the hopes of encouraging improved outcomes.

A relevant example can demonstrate how the data source analysis can be used to foster improved data accuracy and consistency. In the first example, a patient is undergoing a history and physical (H & P) exam by a new primary care physician. During the course of the examination, the primary care physician inquires of the patient the current medications being taken and records each medication, dosage, and duration. The resulting H & P data is recorded by the program 110 in the database 113 according to the type of data (i.e., medications), data document (i.e., H & P), primary data source (i.e., patient name), secondary data source (i.e., physician name), and date and time of data recorded.

Several months later when the patient is getting a medication prescription filled at the pharmacy, the pharmacist pulls up the patient medical record and notices that several errors were recorded in the database 113 in the names and dosages of medications contained within the recent H & P. The pharmacist corrects these errors (i.e., using the program's 110 data editing tool function which tracks the data being modified, source of the edit, substantiating data, and date/time of the event), and refers to the data sources used for validation (i.e., pharmacy database), along with a request to electronically notify the primary care physician (i.e., secondary data source) who recorded these data errors. Upon receipt of the notification, the primary care physician begins to wonder as to the accuracy of other patient provided data, both in the recent H & P as well as other patient related data sources.

There are a number of ways the primary care physician can analyze data directly provided by the patient (i.e., primary data source). Firstly, in one embodiment, the physician can search the data QA analytics provided by the program 110, to review the comprehensive “QA score” of the patient as a primary data source (which is a collective measure of all data provided by the source in question, including the frequency of reported data discrepancies (which can be determined through automated data mining and human data review and feedback) and the severity of these data discrepancies). Secondly, the physician can request an automated review by the program 110 of all primary source patient data; in which those specific data are matched against other (i.e., secondary) data sources to identify any potential data discrepancies. Based upon this analysis, the primary care physician may come to the conclusion that the patient is not a reliable (although unintentional) primary data source and as a result, places a warning in the database 113 for the program 110 to monitor and carefully review all patient provided data, provide future alerts to other clinical care providers of the patient as a primary data source, and remove all unsubstantiated (by secondary sources) patient provided primary data from any of his personal future database 113 searches of this particular patient. While realizing that the patient was not intentionally trying to provide erroneous data or mislead him, the primary care physician sent a message to the patient asking them to bring all medical records, test results, and prescriptions on future visits. When the patient arrived at the emergency room (ER) three weeks later for what appeared to be an allergic reaction to medication, the QA alert was automatically presented by the program 110 to the ER physician when the patient's database 113 was accessed. This provided the ER physician with guidance to scrutinize the information provided directly from the patient and seek out alternative data sources for data verification, accuracy, and consistency.

While manual data entry is always a viable option for recording data into the patient database 113, this would be time consuming and subject to operator error. In one embodiment, an alternative approach would be use of automated data mining techniques (e.g., natural language processing) to extract individual data elements, which can be combined with artificial intelligence techniques (e.g., neural networks) for data classification and determination of relevance (i.e., association relationships between two or more data elements). If we were to take the example of a chest CT exam ordered for evaluation of chronic cough; these computer algorithms run by the program 110, could identify the specific clinical data elements contained within the patient database 113 which would have potential relevance to the exam, anatomy, and symptom of record. These could include chest-related physical exam findings (e.g., lung auscultation), prior surgical history or procedures (e.g., bronchoscopy), pre-existing medical diseases (e.g., emphysema), family history (e.g., cancer), social history (e.g., smoking history), genetic disease predisposition (e.g., lung cancer), laboratory data (e.g., sputum analysis, white blood cell count), and pharmacology (e.g., heart/lung medications). The goal is to create an efficient and accurate methodology of automating data extraction using the program 110, from available patient-specific data sources, while the properly classifying the appropriate data category each data element belongs in, along with identifying “association relationships” between individual data elements, using the program 110.

This last feature is extremely important in creating data sensitivity filters, which, in one embodiment, are an integral and unique feature of the program 110 of the present invention, which allows the end-user to modify the manner in which data is searched and presented, in accordance with the degree of data granularity desired.

To illustrate how this would work, the same example of a patient with chronic cough, who is undergoing a series of imaging tests for evaluation, is described.
a. Chest x-ray
b. Chest CT (pre-existing diagnosis)
c. Chest CT (no diagnosis)

For the chest x-ray (which is a relatively high volume, less technologically advanced imaging exam type), the end-user (e.g., radiologist) does not require the same degree of in-depth and detailed information for rendering a diagnosis as would be required for a more complex imaging study such as a chest CT. Of the various clinical data elements previously described, the radiologist may only need to know existing medical diagnoses (i.e., disease problem list), pertinent laboratory data, and prior surgical procedures. If all of the additional data elements previously described were presented by the program 110 to the radiologist, it could have a perceived negative impact due to excessive (and unnecessary) data and/or additional time requirements (for distinguishing between relevant and irrelevant data). As a result, the program 110 provides the ability to modify the degree of data granularity in accordance with context and user specificity. This could in part be automated through a series of user-defined rules which provide instructions to the program 110 as to which (and how much) data to display for different tasks. Alternatively, the program 110 would have a manual data sensitivity option where the end-user could make real-time (i.e., on the fly) adjustments in accordance with individual needs and preferences in real time. This could be done in a relatively simplistic fashion, where the end-user could adjust the desired level of data granularity up or down (using a scaled system or scroll bar on the display 102), to effectively instruct the program 110 to quantitatively and qualitatively modify the data being presented for review and analysis. One implementation option would be a feature on the user interface (UI) of the present Data Search application which could provide, for example, a sliding scale (for subtle variations in data granularity), or tiered pre-defined sensitivity options (e.g., low, intermediate, high).

In one embodiment, the program 110 has the ability to automatically retrieve and review the data extraction/presentation templates of other users, which can be defined according to end-user profile or context of the task being performed. In this example of a radiologist tasked with interpretation of a chest radiograph, previously used data templates by other radiologists interpreting the same patient's chest radiograph, could also be automatically presented by the program 110 to the user. This provides the end-user with the option of reviewing previously used data extraction templates, which can be particularly helpful when the current end-user does not have a relevant automated workflow template and does not want to manually input data requirements.

In one embodiment, a unique feature of the present invention is the program's 110 ability to integrate the data extraction/presentation template into the document of record (e.g., chest radiograph report, physician consultation note) so that when a third party was to review the document, they would have the ability to simultaneously review the supporting medical data used in analysis. This would be particularly important in the event that a critical piece of medical data (e.g., prior thoracic surgery) was overlooked in performance of the current task (e.g., chest radiograph interpretation). By the program 110 directly accessing the data extraction/presentation used, one can identify whether the data in question was available but overlooked, not available in the data extraction strategy employed (but readily available in unused data sources), or unavailable in all routinely used data sources. This analysis by the program 110 has important utility in education/training, creation and refinement of automated data templates, and medico-legal review.

In one embodiment, an alternative use of the program's 110 data extraction/presentation templates is the ability of the program 110 to directly integrate (i.e., import) source data into the current task being performed. As an example, a cardiologist may want to import previous EKG tracings (graphical data) directly into his/her consultation report for purposes of demonstrating how the prior EKG data effects the current recommendation for medication adjustment. By utilizing the “importation” feature of the program 110, the data of interest can be directly integrated into the current medical document; while simultaneously recording the specific data related to the original data source (i.e., primary/secondary data sources, date/time of data recorded, type of data instrument, etc.), in the referenceable database 113. In many respects, this creates functionality similar to references in a periodical (e.g., journal article), by the program 110 inputting relevant data from alternative data sources while providing attribution of the data source. The presentation mode of this imported data can be customized by the program 110 in accordance with individual end-users' preferences. One end-user may want to display the EKG data in its original graphical format (i.e., tracings), another may prefer the textual impression of the EKG report, while a third end-user may prefer to simply provide a hypertext link, which, if activated, would provide direct access to the original EKG dataset.

Returning to the original discussion of data granularity relating to the different chest imaging exams, it can be seen that an interpreting radiologist requires different degrees of data granularity for a chest radiograph as compared with a chest CT. In the example of the chest radiograph, which is a frequently performed exam using a relatively less sophisticated technology, the report requirements are typically less intensive than that of a lower volume, more complex CT exam. Even two identical exam types (e.g., chest CT) for the same clinical context (e.g., chronic cough) could call for 2 entirely different data sensitivity requirements. For an initial CT (i.e., no prior CT studies) and no known clinical diagnosis, the radiologist reading the study would in all likelihood request a high degree of clinical data granularity, since he/she has little working knowledge related to the patient's medical history. If, on the other hand, the same exam (i.e., chest CT for chronic cough) is being performed on a patient with a known relevant clinical diagnosis (e.g., lung cancer) and is a follow-up exam from an earlier chest CT performed four months earlier, then less clinical data is required.

In this example, the radiologist has a working clinical diagnosis and pre-existing (and recent) imaging data to utilize in the current interpretation process, so the degree of detailed clinical data required is far less than the prior example of a new chest CT without a known clinical diagnosis. Since each individual end-user will have their own unique preferences as to the specific type and quantity of data required, end-user profiles can be created by the program 110 (see U.S. Pat. No. 7,849,115, which is herein incorporated by reference in its entirety), which provide a computerized method of customizing data filtering in accordance with individual end-user's preferences, the context of the task being performed, and historic usage.

In one embodiment, to describe how usage is directly incorporated into data retrieval, presentation, and analysis by the program 110, an end-user's usage of the program 110 can be tracked and measured in several ways including (but not limited to) eye tracking (i.e., visual) patterns, computer input commands, and gestures. Collectively, these human-computer interactions (HCl) define how the end-user navigates and performs a certain task and how data is utilized in the process. The purpose of HCl analysis is to gain insight in defining the common and unique features which characterize how end users interact with the patient database 113 and in turn use this data-derived knowledge to create customized data extraction and presentation templates using the program 110.

In one embodiment, by the program 110 recording and analyzing eye tracking patterns (which has been described in detail in U.S. patent application Ser. No. 12/998,554, filed Jul. 18, 2011, which is herein incorporated by reference in its entirety), relative to the patient-specific database 113, one can determine the specific data which is being viewed and the duration of visual time spent on individual data elements. This in effect creates a visual roadmap detailing the relative importance individual data elements play in performing a specific task (i.e., context specificity), along with the relative importance these data elements play to each individual end-user for that given task (i.e., user specificity). When this data is pooled and analyzed by the program 110 over a large sampling of tasks and end-users, a number of analytics can be derived by the program 110, which can include (but not limited to) the following:

A. Context-Specific Analytics
1. What is the frequency of use of individual data elements relative to the specific task being performed?
2. What are the common (i.e., shared) features of data visualization within a defined user group?
3. When inter-user variability exists (for a specific task), to what degree is it differentiated by the specific content reviewed versus amount of time spent viewing?
4. Does the specific manner of data presentation affect frequency of use, and if so, what are the most time efficient methods of data display/presentation?
5. To what degree does data visualization change (i.e., variability in use) in accordance with external factors such as day/time of task performance, task priority (e.g., stat versus routine), relative workload, and task complexity?

B. User-Specific Analytics
1. For a specific task, what is the degree of inter and intra-user variability?
2. What are the specific end-user characteristics (e.g., age, gender, experience, education, occupation, visual acuity) which are most accurate in predicting eye tracking patterns?
3. Does the specific manner in which data is displayed/presented, affect individual end-user data visualization?
4. Can one create end-user profiles based upon eye tracking patterns (for a given task) and use these profiles to create user-specific automated data templates?
5. Are there certain regions of visual display which are less actively utilized than others, and if so, can this data be used to optimize visual display for individual end-users?
6. To what extent do external variables like visual/physical fatigue and cognitive/emotional stress affect individual end-users' eye tracking patterns and data visualization?

In one embodiment, the goal is for the program 110 to use this eye tracking data and analyses to continuously modify and improve data extraction and presentation for the purpose of improving workflow, stress/fatigue, and clinical outcomes. By the program 110 correlating measures of successful task performance (e.g., report accuracy for radiologists, image quality for technologists) with eye tracking data, the program 110 can identify “best practice” guidelines and patterns of use, which in turn can be incorporated into context and user-specific data extraction and display protocols.

In one embodiment, a similar approach can be applied to other forms of HCl analysis including (but not limited to) electronic auditing tools of the program 110, which monitor user computer input commands (e.g., mouse clicks), or gestures drawn onto a computer screen to track how and what data (from the patient database 113) is being actively reviewed and incorporated into workflow. The goal is for the program 110 to continuously refine data extraction and display in accordance with context and user-specific characteristics, while correlating with performance measures to improve clinical outcomes.

In addition to offering multi-functional data extraction and analysis, in one embodiment, the program 110 also provides multiple options related to data presentation. One of the greatest limitations of existing data display formats in medicine is the relatively fixed and static manner in which data is displayed. Conventional methods of data display largely consist of narrative text reports, which may or may not have supporting numerical (e.g., laboratory) or imaging (e.g., radiology) data. The relative lack of data integration results in the need for the end-user to separately review multiple data sources in order to assimilate and process disparate data elements. One of the primary benefits of the program 110 of the present invention is that it creates a single all-inclusive informational data source, in which data can be compartmentalized and categorized in according to specific data attributes. The end-user can navigate through multiple data categories in a logical and intuitive fashion, with the ability to modify the degree of data granularity based upon data search and analysis in real time. In order to avoid the monotony and fatigue associated with fixed and static data display, the program 110 offers the user the ability to simultaneously present data in multiple presentation states, which can be established in accordance with pre-defined rules or modified spontaneously (i.e., “on the fly”). In addition to multiple visual presentation options (e.g., text, numerical, graphical, pictorial, symbols, icons, annotations, color coding, animation, etc.), non-visual data presentation options (e.g., vibratory, haptic, auditory) can be incorporated by the program 110 into multi-disciplinary data presentation. In one embodiment, the objective is for the program 110 to create a presentation format which is quick and intuitive, dynamic, and customizable, based upon the preferences and viewing patterns of each individual end-user.

As an example, an end-user can create a presentation rule that any data which is recorded by the program 110 in the database 113 as abnormal and of high clinical significance (e.g., laboratory greater than two standard deviations of the norm, pathology data identifying malignancy or infection, imaging finding with recommendation for follow-up biopsy or other interventional procedure), is displayed using an alternative format (e.g., color, bold/increased font size, animation, auditory cue), which effectively provides the end-user with a sensory clue as to its higher priority relative to other data of lesser clinical importance.

In one embodiment, in order to illustrate how this multi-display presentation formatting could be used, an example of a pharmacist (Dr. Lewis) tasked with filling prescriptions for a new patient, who is being treated for refractory hypertension, follows. Based upon the task and end-user profile, the principle data search categories are:
A. Disease: Hypertension
B. Anatomy/Organ System: Cardiovascular (Primary), Renal (Secondary)
C. Primary Data Categories: Pharmacology, Genetics, Medical Problem List
D. History and Physical Data: Physical Exam, Medications, Allergies

The program 110 presents the pharmacist with a targeted review and analysis of data relevant to the diagnosis and anatomy/organ systems of interest (i.e., hypertension, cardiovascular, renal). Both the content displayed and presentation mode provided by the program 110, are specific to the profile of Dr. Lewis, which takes into account his occupational status (i.e., pharmacist), as well as his personal attributes and preferences. After a brief review of the targeted data, which has highlighted content displayed in alternative formats by the program 110 (e.g., blinking, bold and colored displays), Dr. Lewis learns that the newly recommended antihypertensive medication has no direct contraindications or adverse drug interactions (relative to the other medications that the patient is currently taking). Before filling the prescription as ordered (which would be customary at this point in time in conventional practice), Dr. Lewis elects to review the historical record of the patient's hypertension therapy. He can easily perform this task by generating an inquiry to the program 110 to search the database 113 for all hypertensive medications over a defined time period (e.g., 3 years). Since a number of different presentation options are present, Dr. Lewis can defer to the generic default option provided by the program 110, manually select a presentation format, or accept the program 110 generated “preferred” option which is based upon historical usage of himself and other end-users with similar profiles. At any time, he can switch from one option to another by selecting an alternative. By selecting the program 110 generated “preferred” option, he will rely on the program 110 to customize the presentation state for each individual application.

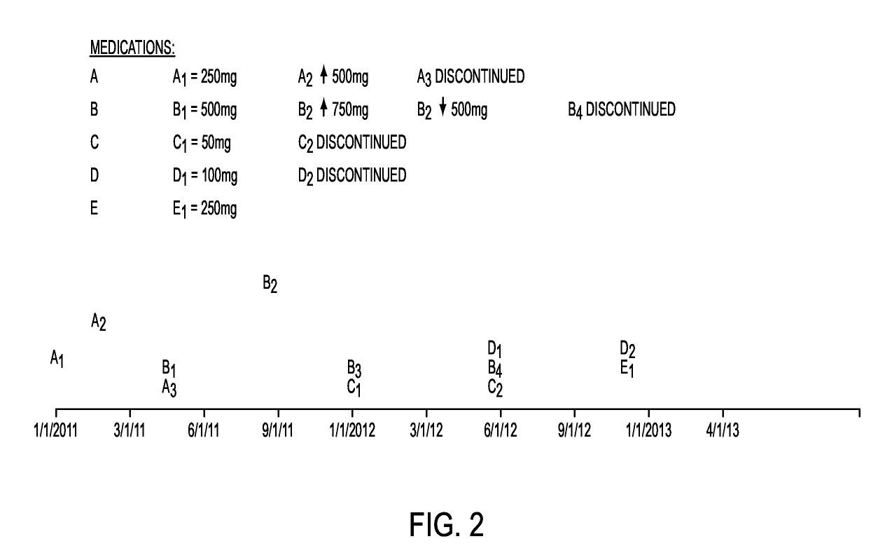

For the first application (i.e., review of hypertensive medications over the past three years), in one embodiment, the program 110 selects a presentation format which displays an annotated chronologic timeline showing the important milestones for each of the individual medications of interest (see FIG. 2). These “milestones” include dates in which a medication was begun, terminated, or altered (i.e., dose modification). If Dr. Lewis selects the option to display “additional clinical data”, he will be presented by the program 110 with a number of “associated” clinical data elements, which have been determined to have association relationships with the individual medications. (Note that the determination of these association relationships can be established by statistical analysis of the database 113 by the program 110, pre-defined rules and algorithms, or manual end-user input). In this case, the association relationships include the following:
1. Physical exam findings (e.g., Blood pressure measurements)
2. Laboratory data (e.g., Renal function)
3. Signs and symptoms (e.g., headaches, visual changes)

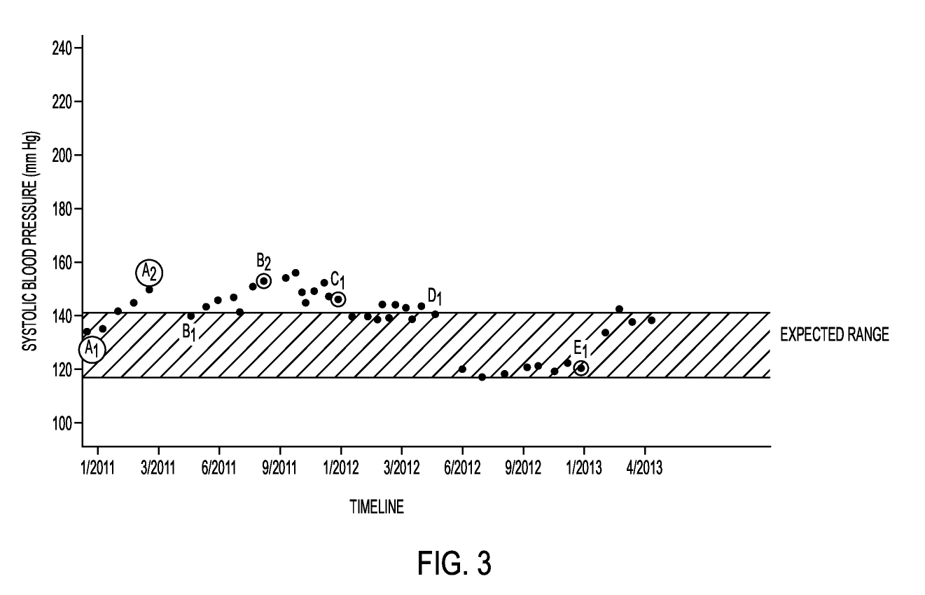

By selecting the option for blood pressure measurements, the program 110 creates a dual graphical display (see FIG. 3) which simultaneously shows the annotated chronologic timeline with medication milestones along with a parallel graphical display of chronologic BP measurements, with a defined range showing two standard deviations for the patient of record. Any outliers from this “patient-specific expected range” are highlighted by the program 110 using an alternative color format and linked with the corresponding medication.

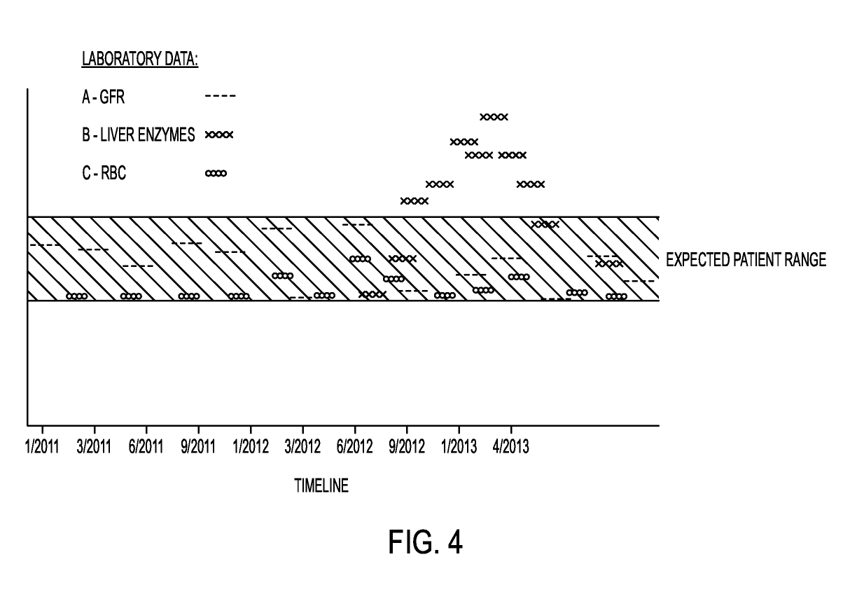

When Dr. Lewis selects the option for Laboratory Data, he is presented by the program 110 with a list of different laboratory data elements which have defined association relationships with both the disease of interest (i.e., hypertension) and individual pharmaceutical agents. In addition to renal function laboratory data (e.g., glomerular filtration rate (GFR), BUN, creatinine) which is directly related to the disease “hypertension”, a number of other laboratory data elements arte specific to individual medications, based upon defined side effects and adverse actions attributed to individual medications. In addition to the program 110 providing an option for reviewing these data on individual bases, the program 110 provides an option to “display outliers”. This in effect provides a short cut for the individual end-user to selectively have the program 110 display on the display 102 those data which fall outside predefined “normal range” or patient-specific “expected range”. In the course of the user selecting this option for “display outliers” along with patient-specific “expected range”; the program 110 presents Dr. Lewis with a targeted snapshot of all associated laboratory data which fall outside of expected values (see FIG. 4). (Note the breadth of these “normal range” and “expected range” values can be adjusted by the reviewer, so that instead of the default of 2 standard deviations, Dr. Lewis could select 1 or 1.5 standard deviations.)

One important point regarding how in one embodiment, the ‘expected range” can be customized and determined by the program 110 is as follows. For a healthy patient without pre-existing disease, the end-user may define the “expected range” as equivalent to “normal range”. In essence, this means that for these patients, normal measures are anticipated and outliers would be defined as values outside of the normal range of two standard deviations. For a patient with a documented disease (e.g., hypertension, renal insufficiency), one would anticipate the “expected range” for this patient would be slightly outside of “normal” values, due to the underlying disease. As an example, the patient being treated for hypertension may have an expected systolic blood pressure measurement in the range of 130-150 mmHg, as compared to a “normal’ range of 110-130 mmHg. If one was to always equate “expected range” with “normal range”, then the majority of measurements would be interpreted as outliers, even though this is the relative norm for this patient. The data analysis and presentation by the program 110 provides the flexibility to modify data in accordance with the unique data attributes of each individual patient, along with the preferences of each end-user (i.e., healthcare provider). The net result is that data can be customized by the program 110 in a context and user-specific manner; with the goal of providing better understanding and utility of the data display and analytics. The creation of a patient-specific “expected” data range can be done either manually by the end-user or by the program 110, which statistically determines the range based upon historical measurements and the degree of variability.

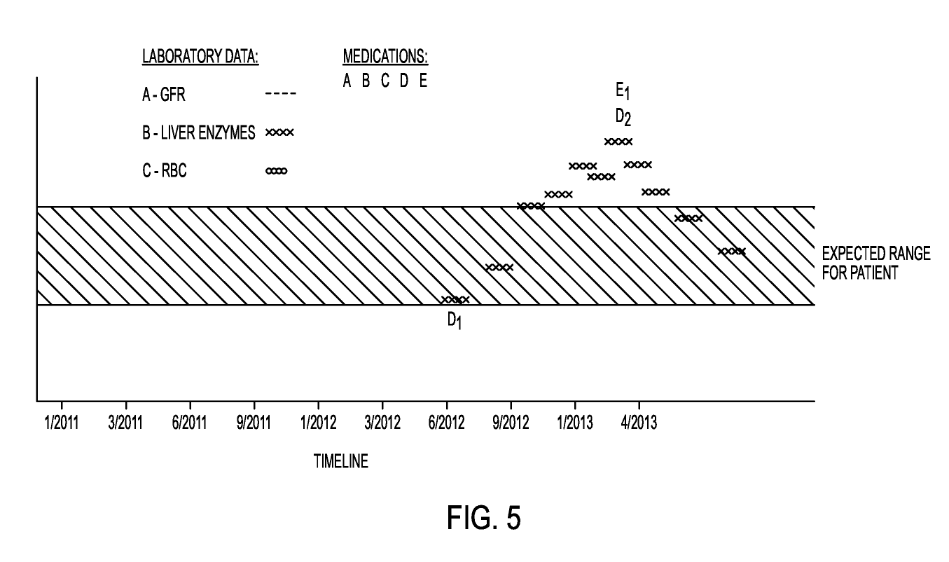

By selecting the option to superimpose all data onto one presentation format, in one embodiment, the program 110 presents Dr. Lewis with a single graphical display which chronologically shows what laboratory values fall outside of the expected range, the dates of these outliers, and the corresponding medication at those times. An alternative display format option provided by the program 110, is to review these outliers on a medication-specific basis, which provides the reviewer with a chronologic snapshot of an individual medication, along with associated data outliers. Dr. Lewis selects this option for one of the drugs which he notices is associated with abnormally elevated liver enzyme measures (see FIG. 5). On review of the graphical display, Dr. Lewis notices that the abnormally elevated liver enzymes closely correspond to the start and stop dates of one specific medication (medication D), and returned to normal levels shortly after that medication discontinuation. This specific antihypertensive drug belongs to the same class of medications as the new medication being described, and as a result, concerns Dr. Lewis for the possibility of this newly prescribed medication potentially causing hepatic dysfunction and elevated liver enzyme measures. Rather than filling the prescription as ordered, Dr. Lewis attempts to contact the prescribing physician and recommend an alternative medication which belongs to another anti-hypertensive class and would have a higher safety profile. The resulting consultation is initiated by the program 110 as an electronic communication by Dr. Lewis, in which he sends the graphical display showing the relationship between the prior antihypertensive medication and elevated liver enzymes, along with a note stating that prior drug causing hepatic dysfunction and the newly prescribed drug both belong to the same class of medications, and as such pose a risk of incurring hepatic dysfunction in the patient. The electronic communication is sent by the program 110 via predetermined means (i.e., email, facsimile, text, etc.). Based upon this consultation and data analysis, an alternative medication is prescribed. This case illustrates what the program 110 can provide, such as data analytical tools, customization features, multiple data presentation options, the ability to utilize this data for interactive consultations, and the ability to interactively annotate data displays (all of which are unique features of the present invention).

### Examples

In an exemplary embodiment, a patient presents to his primary care healthcare provider with a complaint of a worsening cough, fatigue, and weight loss. During the course of his clinical diagnosis and treatment this patient will go through the following steps, each of which involves a different healthcare stakeholder.
1. Initial appointment with primary care provider (i.e., nurse practitioner).
2. Referral for medical imaging (e.g., chest CT) and laboratory testing (e.g., CBC).
3. Performance of the medical imaging exam by a CT technologist
4. Follow-up clinical appointment with primary care provider (i.e., family practice M.D.) to review test results
5. Referral to medical specialist (i.e., pulmonary medicine) for consultation
6. Performance of diagnostic procedure (i.e., bronchoscopy and biopsy) for diagnosis
7. Pathologic analysis of tissue obtained at biopsy (i.e., pathologist)
8. Referral for surgical consultation (i.e., thoracic surgeon)
9. Consultation by cardiologist for pre-operative assessment of cardiac status
10. Performance of surgery for tumor removal (i.e., thoracic surgeon)
11. Referral to oncology specialists (i.e., medical and radiation oncology) for post-surgical treatment planning

In the first step of the healthcare continuum, the patient (i.e., Jack Dunne) makes an appointment with his primary care provider due to a worsening cough which has not responded to over the counter medications. Along with the cough, Mr. Dunne is experiencing fatigue and weight loss, which he attributes to emotional and physical stress, related to economic challenges. At the time of the initial medical appointment, Mr. Dunne is seen by a nurse practitioner (i.e., Ms. Anthony) working in the office of his primary care physician (i.e., Dr. Raditz). Ms. Anthony has seen Mr. Dunne on multiple prior occasions related to a series of pre-existing medical conditions including hypertension, coronary artery disease, COPD, and multiple bouts of pneumonia. As a result of these numerous interactions, Ms. Dunne is fairly well familiarized with Mr. Dunne's healthcare record and as a result elects to review Mr. Dunne's medical database using the following options:
1. Primary Data Search Variables: Cough
2. Data extraction: Targeted
3. Data sensitivity: Low
4. Chronology: 6 months
5. Mode of operation: Automated

By selecting the program's 110 “automatic mode” of operation (which includes the various processes of data extraction, analysis, and presentation), Ms. Anthony is instructing the program 110 to perform all data retrieval and display functions based upon pre-existing rules; which have been created in accordance with occupational status (i.e., primary care provider), her personal user profile, and the specific context of the task being performed (i.e., evaluation of the symptom: cough). The program 110 in turn automatically selects the appropriate primary search categories of chest (anatomy) and pulmonary (organ system); along with the following Data categories and History and Physical Data:
1. Imaging
2. Medical Problem List (complete)
3. Physical exam
4. Present illness
5. Social History
6. Family History
7. Medications

Based upon these program 110 directed search inputs, the program 110 will automatically extract all data referable to the pulmonary system and symptom (cough) which has been recorded in the past six months. The one exception to this “targeted” data extraction is the Medical Problem List, which has been defined by the user (Ms. Anthony) as always being presented by the program 110 in its “complete” data presentation form. In this example for Mr. Dunne, there are 12 different items listed in his “complete” Medical Problem List, which would have been reduced to only three items by the program 110 (all referable to the chest and pulmonary system), had the “targeted” data extraction option been used.

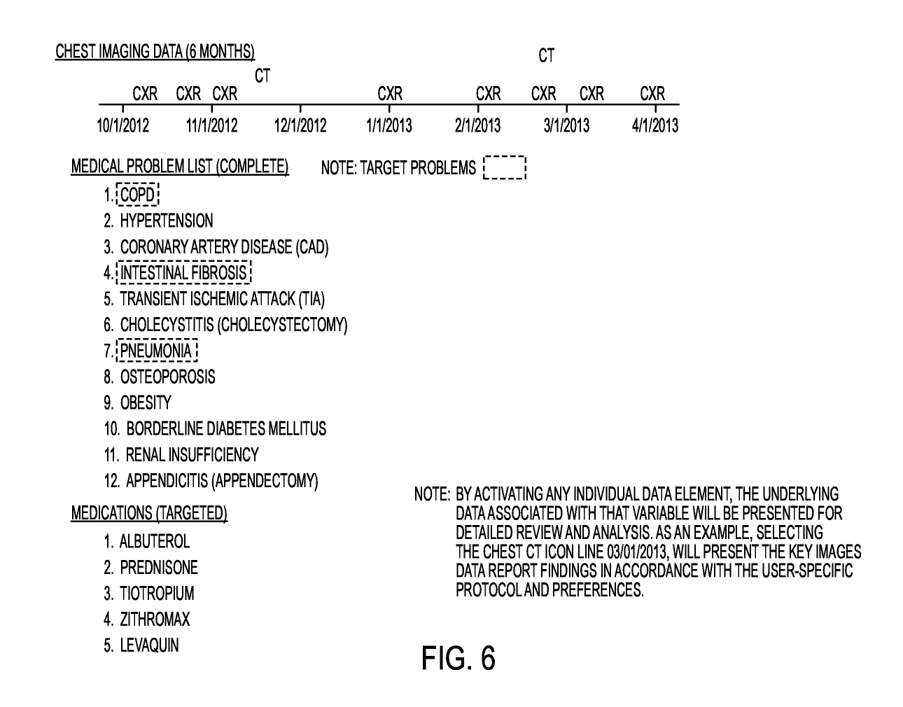

The comprehensive data display by the program 110 (based upon the selected data extraction rules and selections) is shown in FIG. 6, which shows all chest/pulmonary related imaging, medications, physical exam, present illness, and social/family history data. Because the data sensitivity has been selected by the user as “low”, the degree of data granularity presented by the program 110 has been reduced (relative to the intermediate or high options). By the user selecting any individual data element presented in the data “snapshot”, more detailed data will be presented by the program 110, in accordance with the defined end-user protocol and preferences. As an example, if an antibiotic was selected, the dosage, dates of usage, and treatment response would be presented by the program 110 for review. Alternatively, if the chest CT exam on Mar. 1, 2013 was selected, the corresponding key images and report data would be presented by the program 110.

At any point in time of the data review, Ms. Anthony can switch from “automated” to “manual” mode of operation, and input additional data requests to the program 100. In one example, she may elect to expand the search from chest imaging data beyond the designated 6 months interval to 12 months, and in doing so, be presented by the program 110 with additional chest imaging exams performed between 6-12 months. Alternatively, she could request that the program 110 to expand the Pharmacology data by either expanding the chronology (i.e., time) of the search or switch from “targeted” to “complete” data extraction. By expanding the targeted Pharmacology search from 6 to 12 months, she would be presented by the program 110 with additional pulmonary-related medications which were prescribed between months 6-12, which could include an antibiotic regimen in month 8 prescribed for bronchitis, along with a switch in bronchodilators done in month 11. In the other option, by expanding from “targeted” to “complete” Pharmacology data extraction (which is still limited to the past 6 months), she would be presented by the program 110 with the full list of medications prescribed within the past 6 months, irrespective of organ system. In this example, the anti-hypertensive, arthritis, and cardiac medications being taken would be displayed by the program 110.

In the course of doing the latter (i.e., switching from “targeted” to “complete” Pharmacology data within the past 6 months), Ms. Anthony is presented by the program 110 with the anti-hypertensive medication. On further review of physical exam data (under the History & Physical data section), Ms. Anthony sees that Mr. Dunne's blood pressure has been rising above baseline levels (including the current value which was 25 mmHg above baseline), which is of clinical concern. She can explore this further by expanding the blood pressure data (within the Physical Exam data section) search by the program 110 to 3 years (i.e., change in Chronology), and switch from textual to graphical data display. By doing so, the data is now presented by the program 110 in a graphical format showing all blood pressure readings in the past three years. She can then request that the program 110 display an overlay of blood pressure medication changes which will simultaneously display time-stamped alterations in blood pressure (BP) medications along with corresponding blood pressure measurements (see FIG. 3). Since it may be difficult to visualize subtle changes, Ms. Dunne can request the program 110 perform data reformatting, in order to show BP measurements which exceeded an “acceptable” level of 130/80, along with corresponding medications (drug and dose). An alternative search may request the program 110 highlight changes in only the type of medication or dose of a specific medication along with corresponding BP measurements.

Once the clinical evaluation has been completed, Ms. Anthony determines that the current medication regimen is sufficient, but the cough needs to be further evaluated with additional imaging (i.e., chest CT) and laboratory (i.e., complete blood count (CBC)) tests. She places orders for these tests and asks for Mr. Dunne to return for a follow-up visit in 2 weeks.

Upon presentation to the medical imaging department for his scheduled chest CT exam, Mr. Dunne is greeted by the CT technologist who is to perform the exam. The technologist asks Mr. Dunne a series of questions related to his medical history, prior imaging exams, and current physical status. This data is subsequently entered into the Technologist Notes section of Medical Imaging Data under the chest CT section and date of the study (note: this illustrates one method in which data is manually recorded in the database 113). After speaking with Mr. Dunne, the CT technologist returns to the CT workstation and retrieves medical data of Mr. Dunne from the database 113, which will be of clinical and/or technical importance to the study being performed. Just as was the case for Ms. Anthony (i.e., nurse practitioner), the CT technologist (John Mays) has his own profile, which is used for customized data presentation by the program 110, which is specific to context and task being performed. In this example, the following data are used for data customization:
1. Occupational status: Medical imaging technologist
2. Task performed: CT
3. Anatomic region/organ system: Chest/Pulmonary
4. Clinical indication (Sign/symptom): Cough
5. Mode of operation: Automated
6. Data extraction: Targeted
7. Data sensitivity: High
8. Chronology: 12 months

Based upon these data search inputs and the end-user profile, the program 110 will primarily restrict the data query and retrieval to Medical Imaging Data, along with supplemental data referable to the Medical Problem List, Present Illness, Surgery History, Medications, and Allergies. Since the requested level of Data Extraction is “Targeted”; only data specific to the chest/pulmonary system will be displayed by the program 110. At the same time, however, the technologist requested a “high” level of data sensitivity, therefore all data which falls under the designated search criteria will be presented by the program 110, regardless of the degree of detail. For medical Imaging data (which is the primary focus of interest), this will therefore result in the retrieval and presentation by the program 110, of all chest imaging exams and comprehensive reports performed over the past 12 months. (Note that if a “Low” level of data sensitivity was requested, only selected key images and report impressions would be presented by the program 110 for review).

The Primary Data Category (Targeted: Chest): Imaging, and H& P Data (Targeted: Chest): Present Illness, Medications, Allergies, are presented by the program 110 to John Mays (CT technologist) based upon automated data extraction and presentation. Following review of the “clinical” data (e.g., medical problem list, clinical indication, medications, allergies, prior surgery), John may elect to reformat the data by having the program 110 minimize the clinical data and expand the Imaging data field. (This adjustment of data prioritization can be performed by the program 110 in a number of different ways, with the end-user providing instructions to expand the real estate devoted to a specific data category, while minimizing that of other categories. One commonly used method in touch screen technology is to manually expand the size of a specific data source on-screen 102. Alternatively, the end-user could issue a command to the program 110 to “prioritize” a certain data field. The end result is the same in that a single input command would cause the program 110 to selectively expand a certain data field, while minimizing other data fields. All data remains accessible, but is visually presented by the program 110 for review in a disproportionate manner.

This prioritization of the Imaging data field allows John Mays to selectively focus his attention on the imaging data, but still allows him to return to the clinical data section if needed. In addition, by switching from “automated” to “manual” operational modes, John can now actively navigate through the dataset proactively, editing out certain data elements, expanding other data elements, magnifying certain visual components of data, or scrolling through sequential imaging studies at the speed of his choosing. While this data review and navigation is taking place, data is automatically being recorded by the program 110 in the user and context-specific databases 113 using both electronic auditing tools (tracking manual inputs and commands) and/or eye tracking tools (tracking visual movements and actions). These combined data provide critically useful data as to how individual and collective end-users interact and utilize different kinds of data, along with the time spent reviewing individual data components. This data not only provides a tool for creating automated context and user-specific workflow and data templates by the program 110, but also provides an objective means of the program 110 determining “best” and “most efficient” practice patterns among different user groups and profiles, for specific tasks. In the event that certain types of data are repeatedly being underutilized (i.e., ignored or passed over quickly), the program 110 can provide automated prompts to alert the end-user of the cursory or incomplete data review, along with the option of removing this data category from future automated data templates (specific to the task being performed). By providing this data and feedback to the end-user, the program 110 provides an objective measure of the frequency, duration, and manner in which data is being reviewed. Other examples of its use can include (but not be limited to) identification of inefficient eye tracking patterns, excessive dwell times, and identifying periods of relatively high fatigue (which can result in error).

Upon reviewing the Medical Imaging data, John is presented by the program 110 with the option of reviewing all chest imaging data within the defined time period (last 12 months) or restricting the data based upon a number of different variables including (but not limited to) the imaging modality, exam type, clinical indication, technical factors (e.g., contrast administration, acquisition parameters), report findings, and image quality. Since the selected data extraction was “targeted” (i.e., only chest imaging studies) and data sensitivity was “high” (all detailed data included), the data presented will include all chest imaging studies (e.g., conventional CT, high resolution CT, CT angiography, chest radiography, chest ultrasound, conventional chest MRI, chest MR angiography). Since the exam being performed is a conventional chest CT, the technologist elects to restrict the data search, presentation, and analysis to “comparable exams”, which in this case equates to conventional chest with contrast. By doing so, all other chest imaging exams in the predefined time period are removed by the program 110, allowing John to focus his attention on prior chest CT exams, which will be of direct importance in determining the optimal exam protocol for the exam to be performed. In reviewing these “comparable” exam types (which in this example consists of only 2 prior chest CT exams), John realizes the small number of exams (i.e., two) will limit analysis, so he elects to expand the search criteria to three years, which causes the program 110 to expand the sample size to five CT exams. In order to optimize the CT imaging protocol (for both image quality and radiation dose), John has several options. One option is to directly review the imaging datasets (which have already been presented for review) to visually ascertain which exam resulted in the best image quality. An alternative option is to have the program 110 search the corresponding Quality data for the prior chest CT exams and select the exam with the highest quality ratings. A third option is to request that the program 110 undertake an automated analysis of all prior exams to select the optimal protocol for the given technology (i.e., CT scanner being used), contrast agent, patient profile, and clinical indication. This latter option could expand the search to go beyond the patient of record, to include all exams in the collective imaging database 113 which fulfill the search criteria listed.

Once John has determined the optimal acquisition parameters, he then needs to determine the most effective means of contrast administration (e.g., contrast agent, volume, rate of administration, timing of bolus). In addition to reviewing prior patient and exam data retrieved from the database 113 by the program 110, it also becomes necessary to review patient-specific clinical data (e.g., allergies, renal function, venous access) in order to ensure that contrast is clinically indicated and relatively safe to administer. A final component of protocol optimization by the program 110 is radiation dose reduction, which is specific to the individual patient (e.g., body habitus, radiation sensitivity), medical imaging history (date and findings of recent imaging studies, cumulative radiation dose), and clinical context (i.e., clinical indication, pathologic diagnoses). A practical methodology for simultaneously optimizing radiation dose and image quality had been reported in U.S. Pat. No. 8,412,544 (the contents of which are herein incorporated by reference in its entirety), and this technology and resulting data can be integrated by the program 110 into the present invention. In the end, one of the principal goals of the present invention is to create a dynamic and customizable method for data retrieval, display, and analysis. Protocol optimization is one example of how data analysis from the invention can be used for decision support at the point of care.

After the imaging exam is performed, it is transferred to the radiologist where it is interpreted. While the three primary data requirements for a CT technologist are data related to the exam clinical indication (i.e., why was the exam ordered?), historical imaging exams, and protocol optimization, other data priorities exist for the radiologist. These inter-stakeholder differences in data requirements are largely occupational in nature, and intrinsically tied to task performance differences. While a technologist is tasked with exam acquisition (which should be optimized for image quality and patient safety), the radiologist is tasked with exam interpretation. As a result, the radiologist has demands for more in-depth clinical data, historical imaging data, and diagnostic decision support tools (e.g., computerized differential diagnosis, association relationships between imaging and clinical data elements). Along with these basic “occupational requirements”, each individual radiologist has his/her own unique preferences, which can in part be tied to their individual profile by the program 110. These inter-group data differences that are taken into account by the program 110, can include (but are not limited to) the specific types of data required (i.e., categorical data), the granularity of data desired for each individual data category (i.e., data granularity), the manner and style in which data is presented (i.e., data presentation format), the various methods in which data is analyzed (i.e., data analysis), and specific workflow preferences (i.e., data input and navigation).

In one embodiment, in order to illustrate how these inter-group differences manifest themselves, data requirements and preferences are shown below to differ for three representative radiologists, each of which is tasked with interpretation of the same chest CT exam in this representative case study. The analogies of how these inter-group differences are manifested can be extrapolated to essentially any stakeholder group and task in the healthcare continuum. The three radiologists are designated as A, B, and C with attributes as described below:
1. Radiologist A: general radiologist practicing in a rural 100 bed hospital
2. Radiologist B: subspecialty-trained thoracic radiologist practicing in an metropolitan academic tertiary care hospital
3. Radiologist C: general radiologist practicing in a suburban high volume outpatient imaging center

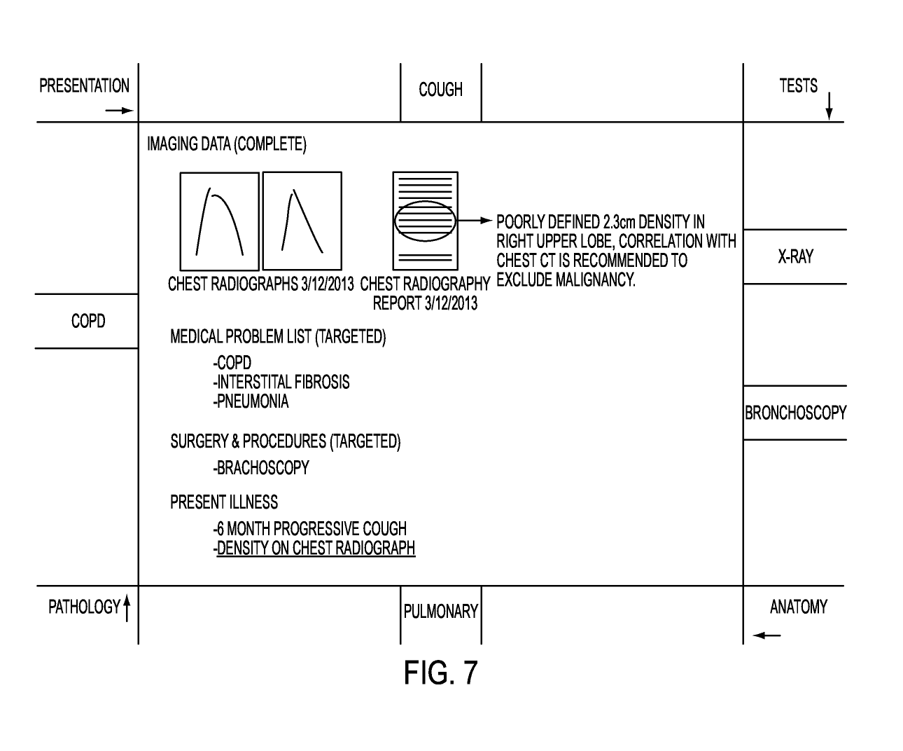

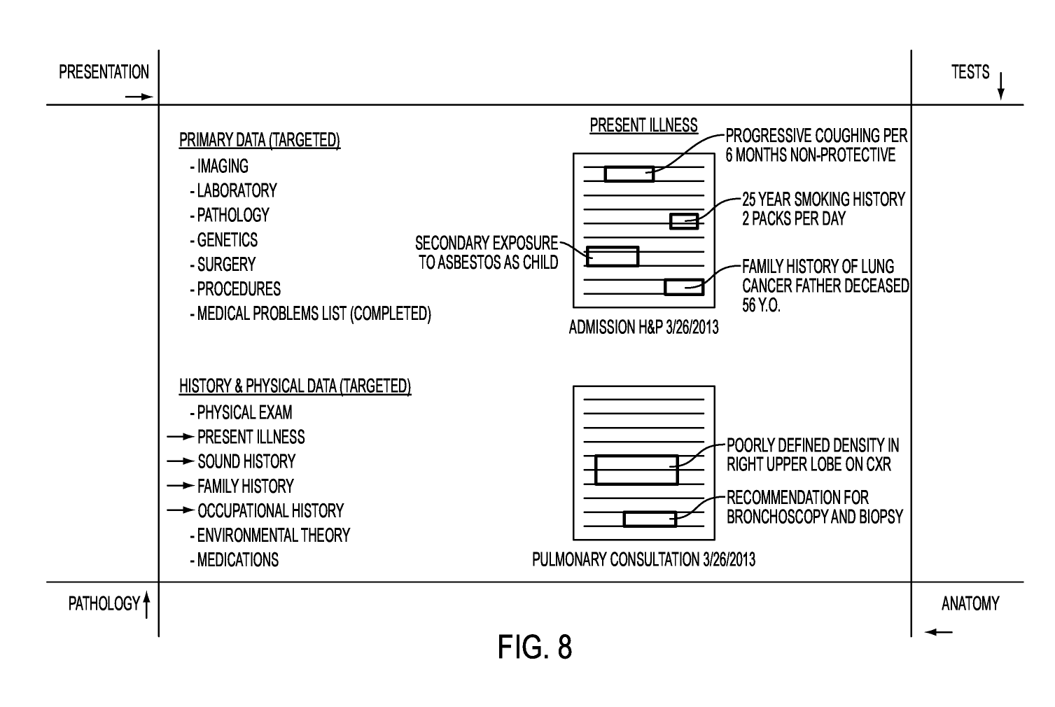

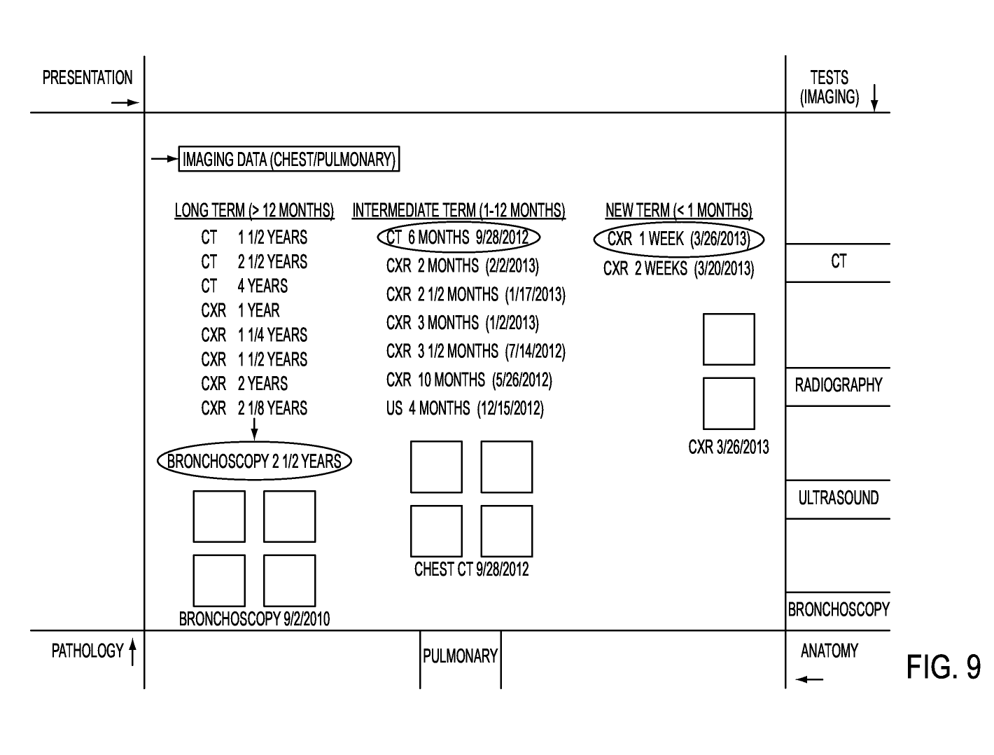

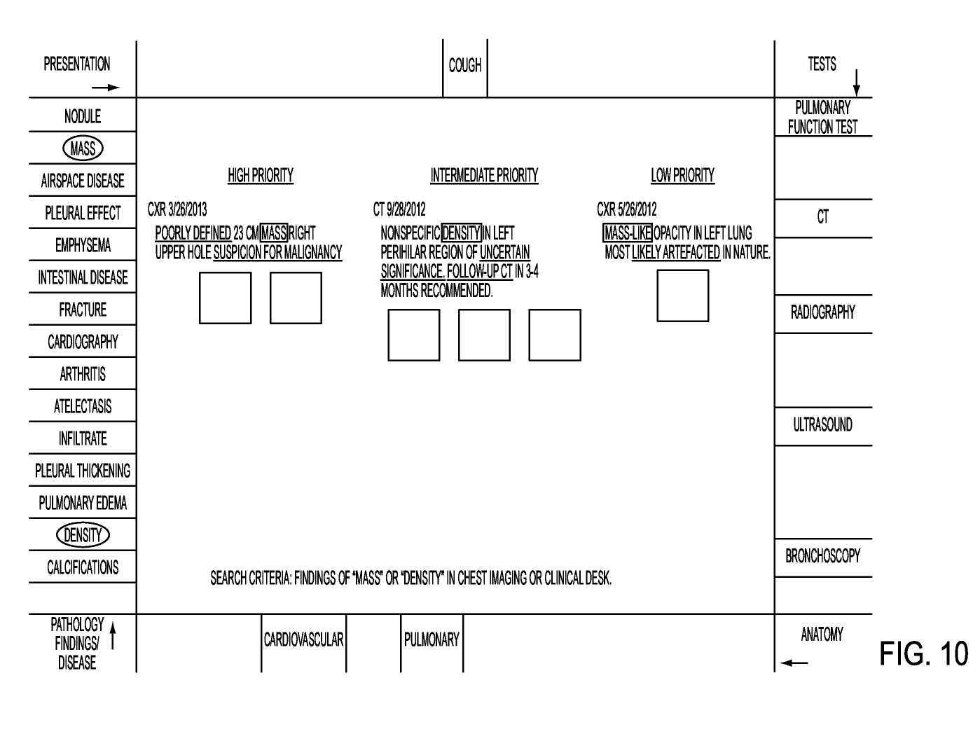

A number of commonalities exist to all three radiologists, relating to the basic data requirements. In all cases, the radiologists require clinical data related to the present illness, relevant surgeries, and the medical problem list. At the same time, all three radiologists require historical imaging data related to relevant prior imaging exams (relevant defined as similar anatomy and exam type). These common data requirements are, for example, The Primary Data Category (Targeted: Chest): Imaging, and H& P Data (Targeted: Chest): Present Illness, Medications, Allergies. Differences in data requirements can take a number of forms (which are too numerous to individually detail), with representative example for all three radiologists presented in FIG. 7 (Radiologist A), FIGS. 8-9 (Radiologist B), and FIG. 10 (Radiologist C). A brief description of these differences in data requirements and preferences are described below.

Radiologist A (FIG. 7) has practiced for over 30 years in a small rural hospital, which has relatively antiquated technology, less sophisticated technologists and medical staff (in terms of subspecialty training), and serves a general patient population. As a result, Radiologist A's data requirements are fairly straightforward and basic. His customary clinical data preferences are for “targeted” data (as opposed to “complete” data), and rarely exceed the aforementioned data basics of present illness, relevant surgeries, and relevant medical problem list. With regards to imaging data, Radiologist A typically likes to review the single most recent comparable medical imaging dataset and report. In doing so, he will review the entire imaging dataset and corresponding report (i.e., “complete” imaging data); and use this single comparison imaging data for current exam interpretation and reporting.

Radiologist B (FIGS. 8-9) has different data preferences and requirements; which in part are attributed to her educational differences as a subspecialty trained thoracic radiologist and practice within an academic hospital which serves a more specialized medical staff and patient population. In addition, as part of a teaching hospital, both technologists and radiologists in training play an integral part of daily workflow, where research and education actively practiced and the technology utilized is state-of-the art. The net result of these combined personal and institutional characteristics (i.e., radiologist and institutional profiles) is that the data requirements for Radiologist B are far more robust, in breadth and depth than those of Radiologist A. In FIGS. 8-9, one can see that the clinical data requirements go beyond the three common requirements of present illness, surgery, and medical problem list and expand into physical exam, historical data (e.g., social, family, occupational, and environmental), laboratory/pathology, genetic, procedure/test, and pharmacologic data. The extraction of these additional data requirements by the program 110 are largely context-specific, and are driven by a combined set of computer algorithms and physician directed rules. In this example of a chest CT for chronic cough and longstanding COPD, Radiologist B requires a number of historical clinical data related to social history (e.g., smoking), family history (e.g., cancer), environmental and occupational history (e.g., exposure to carcinogens). In addition, Radiologist B always desires an overview of all other categorical clinical data including physical exam, medications, surgeries, procedures/tests, laboratory, pathology, and genetic data. Since the historical and clinical data requirements are highly context-specific, Radiologist B routinely requests the program 110 retrieve “targeted” historical clinical data as the baseline, but will frequently expand the data search manually to “complete” data, if deemed to be additive for diagnostic or teaching purposes. Since the number of clinical data categories are quite numerous (compared with the “basic” three data categories of Radiologist A), the manner in which data is presented is of critical importance to Radiologist B. If one was to attempt to “cram” all of this clinical data in text format onto a single computer screen, the efficacy of data review and assimilation would likely be negative impaired. As a result, Radiologist B has opted for an alternative display format from the program 110 which utilizes a combination of graphics, text, and tabular data, combined with an overview which highlights certain data elements (using color, sound, and alternative font) to emphasize certain data deemed to be of “higher priority”. These “high priority” clinical data are similarly identified by the program 110 using computer algorithms and user-specified rules and feedback. Examples could include recent interval worsening (e.g., increasing fever or lab values), new or recently changed medications, high level disease risk factors (e.g., genetic predisposition, occupational exposure to carcinogens), or recent clinical diagnoses (e.g., pathology, clinical test results).

Similar differences in inter-radiologist data comprehensiveness also hold true for imaging data requirements. While Radiologist A merely required data from the most recent comparable exam, Radiologist B has far greater imaging data preferences. In this example, the combination of longstanding smoking history, COPD, recurrent pneumonia, and worsening cough calls for a greater review of historical imaging data. This expansive review of historic imaging data requires expanding the scope of imaging data retrieval from the program 110 to include all chest imaging exams (e.g., chest CT, MRI, radiography) over a prolonged time period of three years. Due to the fact that this encompasses a far greater quantity of data, Radiologist B has elected to have this data presented in “targeted” form by the program 110, which includes key images and report impressions (as opposed to complete imaging datasets and reports). In the event that any specific imaging data requires more extensive data review, Radiologist B can simply invoke a manual input command (e.g., mouse click, speech) to have the program 110 expand that specific data from “targeted” to “complete”.

In one embodiment, another unique feature of the invention commonly utilized by Radiologist B is the ability to create and analyze association links between two or more data elements (see U.S. patent application Ser. No. 12/659,363, filed Mar. 5, 2010, the contents of which are herein incorporated by reference in their entirety). These data association links can be established using both manual and automated means. When a manual association link is proposed, the end-user can query the computer database 113 to determine the statistical probability of the theoretical relationship (using the program 110 to combine data mining and artificial intelligence technologies), the relative strength and nature of the association relationship, and whether such a relationship has been proposed by other end-users. For Radiologist B, this feature is particularly valuable in the program's 110 capacity to serve as an education/teaching aide, facilitator of clinical/imaging research, and component to clinical decision support and analytical tools. Relevant examples for this particular case study could include the linkage of the primary chest CT finding (i.e., mass) to a variety of clinical data elements including (but not limited to) 25 pack year smoking history, genetic markers for lung cancer, 15 pound weight loss, symptoms of cough and fatigue, and occupational/environmental exposures to asbestos, benzene, and diesel fumes.

Radiologist C (see FIG. 10) has data preferences which are somewhat in between Radiologists A and B, but the most important unique distinction between Radiologist C and his peers are workflow related. While Radiologists A and B primarily interact with the data through manual input, Radiologist C relies largely on automated workflow templates in order to maximize productivity, workflow, and consistency. This productivity-centric approach to data retrieval, presentation, and analysis is largely a reflection of the extremely high exam volumes Radiologist C experiences in his routine day to day practice. This utilizes almost entirely targeted data of low sensitivity, where the program 110 provides maximal efficiency of covering a number of different clinical and imaging data categories with a minimum amount of detail. One tool utilized by Radiologist C to facilitate this productivity-centric approach is to have the program 110 differentially display imaging data on a finding-specific basis, as opposed to the conventional method of displaying imaging data in a comprehensive “all inclusive” manner. Conventional display of imaging report data utilizes presentation of textual data in either complete (i.e., entire report) or abbreviated (i.e., report impression only) display formats. An alternative approach used by Radiologist C utilizes data retrieval and presentation by the program 110 on a finding-specific basis, in which individual findings form historic imaging reports are extracted and presented in a hierarchical fashion in accordance with perceived clinical significance. (The classification and categorization of individual findings into different levels of clinical significance can be performed by a program 110 derived analysis taking into account a list of associated variables contained within the report including (but not limited to) temporal change, quantitative measurements, morphologic characteristics, follow-up recommendations, and differential diagnosis. In some cases, the clinical significance is actually classified in the report (e.g., high clinical significance, emergent, incidental, etc.). This finding-specific alternative to data presentation can be combined with graphical icons and symptoms (which map to the text-based findings) for the program 110 to provide a quick and intuitive method for reviewing and searching historical data.

As an example, in the course of interpreting the current chest CT exam, Radiologist C identifies a right upper lobe mass, which he suspects could represent malignancy. In order to more efficiently search a large number of historic imaging data, he could command the program 110 to search for the specific finding of “mass” and related findings (e.g., lesion, density, opacity) on all prior imaging exams. By doing so, the program 110 would present all prior imaging reports which fulfill the search criteria, which could in turn be narrowed down according to a number of variables including (but not limited to) anatomy, organ system, exam type, and date. In a similar fashion, Radiologist C could initiate a prospective data search with the program 110 (i.e., prior to interpretation of the current study), which identifies all historical data which could be related to the current clinical indication (i.e., cough, fatigue, weight loss). This effectively creates an alternative (and arguably more efficient) method of data retrieval, presentation, and analysis by the program 110, which obviates the requirement to review large narrative textual reports.

After completion of the chest CT, Mr. Dunne is scheduled for a follow-up visit to his primary care practitioner for a clinical re-evaluation and review of the imaging and laboratory test results. Before the time of his scheduled appointment, the clerical staff notified both the nurse practitioner (Ms. Anthony) and the physician director (Dr. Raditz) of the CT report findings, which described a right upper lobe lung mass suspicious for cancer. As a result of this information, Dr. Raditz directly reviewed Mr. Dunne's patient record in the referenceable database 113, with a primary emphasis on the recent chest CT imaging data and additional clinical data which could be related to a potential diagnosis of lung cancer. This diagnosis-driven data review utilizes the search capabilities of the program 110 to identify all relevant medical and imaging data in the database 113 which could support (or refute) the clinical diagnosis in question. This can be accomplished by inputting the specific search criteria into the program 110 and requesting the program 110 perform the following functions:
1. Search all data categories for relevant data (which support or refute the diagnosis in question).
2. Provide a statistical measure of diagnostic certainty, based upon the cumulative analysis of data.
3. Identify those specific data elements which have the highest degree of predictive value (i.e., rank order of data significance).
4. Identify additional “missing” data elements which would be of value in improving diagnostic certainty.
5. Determine data sources (i.e., additional tests, procedures, consultations) which would be of potential value, along with an itemized cost/benefit analysis (e.g., complication risk, economic cost, availability).

Based upon the diagnosis-driven search for “lung cancer” by the program 110 in database 113, the imaging data presented for review by the program 110 includes the imaging datasets and reports of the recent chest CT, prior chest CT exam performed 18 months earlier, a recent chest radiographic exam performed two months earlier, and a cervical spine CT exam performed 10 months earlier (in the evaluation of neck pain). Based upon the request for “targeted” data, the imaging data presented for review by the program 110 includes key images (which are single images specific to the finding or diagnosis of interest) and targeted report data (consisting of data specific to the finding or diagnosis of interest). Of particular interest is the following targeted report data:
a. Chest CT 18 months earlier: No evidence of malignancy.
b. Neck CT 10 months earlier: Poorly defined density in the incompletely visualized right upper lobe.
c. Chest radiograph 2 months earlier: Multifocal densities suspicious for bronchopneumonia.
d. Chest CT current: New 4.2.×2.1 cm right upper lobe soft tissue mass suspicious for malignancy, biopsy recommended.

In order to better understand the temporal nature and significance of these findings, Dr. Raditz requests for the key images of these imaging exams to be linked and modified by the program 110 (i.e., image processing) to highlight the region of interest using the right upper mass on the recent chest CT as the reference point of interest. By doing so, the program 110 provides side by side image display of the key images from the 4 sequential studies of interest, along with the supporting targeted report data. In doing so, the combined CT and radiographic images show interval growth of a poorly defined mass which was not clearly visualized on chest CT 18 months earlier, became apparent on the cervical spine CT 8 months later, and substantially grew to its current state on the current chest CT. Visualization on the chest radiographic image two months earlier was difficult due to the presence of bilateral airspace disease in association with pneumonia. An important piece to this analysis was that the abnormality in question (i.e., lung mass) was reported as a “poorly defined density” on the cervical spine CT, which was largely ignored due to the fact that the exam in question was of a different anatomic region (i.e., spine), ordered by a different healthcare provider (i.e., chiropractor), and was described in non-specific terminology (i.e., density), without follow-up recommendation.

In one embodiment, along with the sequential imaging and report data, the program 110 graphically plots interval growth of the mass, a calculated doubling time, differential diagnosis, and estimated malignant severity. These values will be further enhanced with additional pathologic data and genetic analysis in the event the mass undergoes tissue biopsy. These combined data will be useful in determining malignant severity, prognosis, and treatment planning.

Based upon the comprehensive data review, Dr. Raditz is convinced the likelihood of lung malignancy is high and biopsy is required for definitive diagnosis. He then utilizes the “screen capture” function of the program 110 to preserve the specific data elements and presentation state for subsequent patient consultation (at the time of Mr. Dunne's scheduled visit). In addition, this diagnosis-specific screen capture data (both medical and imaging data) can be forwarded by the program 110 via electronic means (i.e., email, text, facsimile etc.) to the consulting pulmonologist (who will likely be performing a bronchoscopy for diagnostic biopsy), as well as the orthopedic surgeon who had requested the prior cervical spine CT. This provides that physician with feedback related to a potentially “missed diagnosis”, which could be of value for both educational and medico-legal purposes.

When Mr. Dunne arrives for his scheduled visit and review of test data, he is presented with the screen capture data which visually shows the lung mass in question, along with clinical risk factors. The cost-benefit analysis data provides insight as to the recommendation for bronchoscopy, as opposed to alternative diagnostic tests/procedures. In the event that he wished to get a second opinion, this data screen capture function of the program 110 would serve as a valuable data source, while maintaining data consistency in the clinical evaluation.

An important benefit of the targeted data analysis and screen capture function of the program 110 is that it provides a methodology to render timelier healthcare delivery and decision making. Upon electronic receipt of the screen capture data forwarded by the program 110, the pulmonologist (Dr. Henry) has the opportunity to review the targeted data immediately, initiate additional data inquiries and analytics to the program 110 that he deems beneficial, and prepare for “next steps” in clinical diagnosis, treatment, or management even before he sees Mr. Dunne directly. While final decision-making is not made until after he has examined and spoken directly to Mr. Dunne, important time sensitive planning steps can begin (e.g., scheduling of additional laboratory, consultations, or clinical tests). When Mr. Dunne arrives for his scheduled appointment, Dr. Henry is up to date on the relevant clinical and imaging data, and has already prepared a number of clinical options for Mr. Dunne to choose from. Dr. Henry has researched scheduling opportunities for bronchoscopy which he presents to Mr. Dunne. Based upon the prior visit with Dr. Raditz, Mr. Dunne is already prepared for the bronchoscopy and asked that it be scheduled at the earliest convenience of Dr. Henry. During the course of the consultation, Dr. Henry opts to schedule the bronchoscopy with Mr. Dunne in attendance, which provides the opportunity to obtain informed consent with biometrics documentation (Biometrics patent). The ability to schedule the procedure through the program 110 can be performed by highlighting the Procedure/Test data category, selecting Bronchoscopy (which is an option automatically presented when the Pulmonary Organ System is selected), and then select the “Scheduling” option. (Note a number of options exist for data review and analysis when a test/procedure option is selected. These include (but are not limited to) patient data review, patient data analysis, meta-analysis, scheduling, associated clinical/imaging data, related tests/procedures, complications, and risk factors). When the user selects the “scheduling” option for bronchoscopy, the program 110 searches the database 113 to assess a number of patient-specific data which could have an impact on the procedure in question and its scheduling options. These include patient risk factors (related to the procedure, required prep, and anesthesia), insurance restrictions, geographic/institutional preferences, patient and physician availability (i.e., potential scheduling conflicts), and pre-procedural testing/consultation. Using artificial intelligence techniques (e.g., neural networks), the program 110 searches the patient database 113 to identify any additional data requirements, aberrant data, or risk factors which could affect scheduling and/or performance of the procedure in question. One of the analytics which can be derived from this search and analysis by the program 110 of the patient database 113 (which in turn can be correlated by the program 110 with aggregated meta-data from patients with similar medical profiles) is a “medical risk index”, where the program 110 determines the relative health risk posed by the procedure relative to the patient past procedural history, medical problem list, medications, current physical exam findings, laboratory and test data, allergies and prior adverse drug reactions, and current symptoms. This derived index can in turn be used by the program 110 in a number of different ways including (but not limited to) determining the relative risk versus benefit ratio of the procedure in question, identifying alternative test/procedure options of lower risk, and identifying patient-specific risk factors of interest. (Note by the program 110 pooling this data over large patient populations and accounting for the myriad of data elements within these patient databases 113, large sample statistics can be derived which are iterative and consistently refined and tested as additional outcome data is received and incorporated into the derived analytics.)

In the course of this program 110 derived analysis of the patient (i.e., Mr. Dunne's) database 113, a number of risk factors are identified by the program 110, which result in a relatively high medical risk index for the proposed procedure (i.e., bronchoscopy). These include COPD, coronary artery disease, hypertension, and TIA, each of which has its own supporting data which is used in the analysis by the program 110 and is presented for review on the display 102. While the COPD is a well-known risk factor to Dr. Henry (as a pulmonologist), the other three disease processes are of concern and fall out of his subspecialist expertise. One item which has been flagged by the computer of “high significance” is coronary artery disease, which has an associated recent test result of abnormal EKG showing left heart strain. The program 110 presents the following options to Dr. Henry as to next steps:
1. Proceed with procedure testing, accepting the medical risk index as high but believing the derived benefits of performing the procedure outweigh the risks.
2. Obtain a cardiology consultation to review the risks of coronary artery disease, hypertension, and TIA prior to procedure testing.
3. Cancel the procedure and evaluate alternative tests or procedures with a lower medical risk index (e.g., CT guided percutaneous biopsy under local anesthesia).

Based upon the options presented by the program 110, and after consultation with Mr. Dunne, it is decided that the best course of action for both parties (physician and patient) would be to obtain a cardiology consultation, which could simultaneously determine the relative risk of the planned procedure, while also looking to improve medical treatment of the disease entities in question. One of the many benefits of the present invention is that the specific data which has been brought to Dr. Henry's attention can be saved and automatically presented by the program 110 to the cardiologist at the time the consultation order is received. This ability of the program 110 to save, capture, and present a targeted data “snapshot” of the patient ensures that the most important and relevant information will be directly reviewed, all parties are working from the same data reference point, the consultation process is highly efficient, and the shared data “snapshot” provides an easy to use and portable instrument for bi-directional electronic communication and consultation between the various parties.

Once the cardiology consultation order has been placed (along with the electronic snapshot of pre-selected data by the program 110), it is received by the cardiologist (Dr. Johnson), who in turn can electronically acknowledge receipt via the program 110, and schedule the consultation appointment by matching the schedules of Mr. Dunne and Dr. Johnson. The ability to preliminarily review the data and clinical question posed, allows Dr. Johnson to perform some of the consultation and analysis prior to directly seeing Mr. Dunne. This provides an additional opportunity to request any additional laboratory or clinical test data prior to Mr. Dunne's scheduled appointment time. The goal therefore is to shorten the time requirements in completing the stated task and maximizing the clinical end result by having all relevant data available, in order to achieve the most accurate clinical assessment.

In the course of reviewing the snapshot data presented by the program 110, Dr. Johnson has the ability to instruct the program 110 to (automatically) retrieve all relevant clinical, imaging, and pharmacologic data related to the diagnoses in question, which includes the following:
1. EKG tests
2. Serial BP measurements
3. Medication orders and adjustments
4. Carotid artery ultrasound exam
5. Coronary artery angiogram
6. Head CT
7. Treadmill stress test

For review of the EKG tests, Dr. Johnson's profile (i.e., user-specific preferences for data display presentation) calls for serial EKG studies performed over the past three years to be graphically displayed by the program 110 in a vertical chronologic order, with the most recent exam at the top and the last exam at the bottom of the display screen. An additional component of Dr. Johnson's profile has the program 110 request that all reported EKG abnormalities be annotated (using a standardized annotation schema) and linked to corresponding text in the EKG report. A third component of the profile has the program 110 incorporate a finding-specific “linking” function, which effectively links similar findings across multiple studies. (This can be performed in a number of ways by the program 110, including color and numerical coding of individual findings).

On review of the most recent EKG (performed 8 weeks earlier), Dr. Johnson notices one finding of particular concern which is reported by the program 110 as “left heart strain”. Dr. Johnson can search for this finding on earlier EKG exams through either automated or manual search techniques. In the manual technique, Dr. Johnson would visually scan prior EKG graphics and text reports in search of the finding/s or interest, and then annotate the specific regions of interest for linking across multiple studies. In the automated technique, Dr. Johnson can input the finding of interest (in either graphical or text formats) and ask the program 110 to search and identify the presence of this finding on prior studies (along with a statistical measure of confidence). Dr. Johnson selects the automated option by annotating the current EKG graphic showing the region of left heart strain and linking that to the corresponding report text. He then selects the “find all” option with the restriction to “EKG” as the data source. The program 110 in turn highlights all prior EKG studies within Mr. Dunne's patient database 113 which contain either the graphic attributed to left heart strain or the words “left heart strain” in the report. (The search can also have the program 110 identify synonyms in text reports when applicable).

In the course of the program 110 search and analysis, one prior EKG was shown to contain left heart strain in both the graphical display and report, while a second EKG was found to contain the left heart strain graphical display, but did not contain corresponding text in the report. Two additional data sources were found by the program 110 to contain the requested data which fell outside of the search parameters and these are presented by the program 110 for the option to review (i.e., inset box notifying the user of additional data with the options to “review now”, “store and review later”, and do not review”). When Dr. Johnson selects the “review now” option, he sees that one data source was an EKG 4½ years earlier (which fell outside of the three year search criteria), and the second exam was data from a cardiac stress test (which technically is not recorded in the database 113 as an “EKG”, but instead recorded under the test type “cardiac stress test”. (Both options are recorded by the program 110 as data sources under the anatomy/organ system of “cardiovascular” and would therefore, be presented under a targeted search of coronary artery disease.)

Upon detailed review (which is recorded in the eye tracking analysis by the program 110), Dr. Johnson comes to the following conclusions:
1. The finding of left heart strain was present in three out of the four identified data sources, one of which was unreported and another of which was erroneously reported but not present (i.e., misinterpretations).
2. The severity of the left heart strain (and resulting computer-derived diagnostic confidence) was greatest on the most recent EKG test performed 8 weeks earlier.
3. The finding of left heart strain was identified on all three occasions when Mr. Dunne's hypertension was poorly controlled and outside of his normal range.

This association relationship between left heart strain and hypertension can be visualized and recorded by the program 110 by temporally linking the date/time of the EKG finding (i.e., left heart strain), with the date/time of sequential blood pressure recordings which fall outside of the baseline patient range. From a practical standpoint, Dr. Johnson did this by choosing to display the blood pressure measurements on a timeline and then superimposing the dates of the EKG studies. Those three EKG/stress studies showing the finding of left heart strain were then temporally linked by the program 110 to the blood pressure measurements closest in time. Using artificial intelligence techniques (e.g., Bayesian analysis), the program 110 in turn derived a numerical value of correlation between the two data elements to show what it believed was the statistical probability that the two data elements were indeed related to one another.

Two other data sources of interest to Dr. Johnson were the carotid artery ultrasound exam and coronary artery angiogram. Although the carotid artery ultrasound exam was relatively recent (performed 6 months earlier), the report was inconclusive due to the presence of patient motion and noncompliance (which was contained within both the report text and quality sections of the Medical Imaging database 113 by the program 110). Secondly, the coronary angiogram was performed 6 years ago and the results are therefore, old.

As a result of this medical data review and analysis (and after examining Mr. Dunne), Dr. Johnson came to the conclusion that Mr. Dunne's current cardiac condition precluded scheduling of bronchoscopy until the following items were successfully addressed:
1. Adjust current hypertension medications to ensure blood pressure is consistently brought to within an acceptable range.
2. After this has been successfully completed, repeat the cardiac stress test; in the hopes that this one test will address current concerns of left heart strain (on EKG) and the long time elapsed since prior coronary angiography.
3. Repeat the carotid artery ultrasound to ensure that no significant stenosis is present which would place the patient at increased risk for anesthesia associated with bronchoscopy.

The resulting consultation captured the essential data used in the analysis along with the supporting data used to arrive at the conclusions made. An important feature of the present invention was that this new data (e.g., the program 110 linking graphical data between EKG left heart strain and elevated BP measurements) was automatically recorded in the patient database 113 by the program 110 along with the date, time, and identity source of the data. In this case, the graphical data linking EKG left hear strain and BP measurements was attributed to Dr. J Johnson on Apr. 4, 2013 at 3:15 pm and incorporated by the program 110 into Cardiology Consultation Report. The program 110, thus, provides a valuable method of authenticating data, monitoring and validating data sources, and providing targeted user and context-specific educational feedback as new data is recorded (which confirms or negates the data previously recorded).

In one embodiment, another important function of the present invention is the ability of the program 110 to use this data for patient education, physician consultation, data documentation, and informed consent. In this example, once the Cardiology Consultation was completed, Dr. Johnson reviewed the data with Mr. Dunne along with his recommendations. Once any questions were addressed and satisfactorily answered, Mr. Dunne then confirmed receipt of the information using the program 110, confirmed an understanding of the analysis and conclusions reached, and agreement with the current action plan. Once the same process was performed through electronic communications between all principal parties (i.e., Dr. Raditz, Johnson, Dr. Henry, and Mr. Dunne), using the program 110, the Carotid ultrasound and cardiac stress tests were scheduled pending successful adjustment of the hypertension medication.

Upon successful completion of these recommendations, the new and updated data within Mr. Dunne's database 113 reflected positive change in the bronchoscopy medical risk index, which now feel within an acceptable range to proceed with the procedure.

The aforementioned case study simply serves as an illustration to show how medical data can be classified and categorized in accordance with the major and primary data categories and extracted, displayed, and analyzed in a context and user-specific fashion, using the program 110 of the present invention. A number of unique applications are described related to methods for ensuring the data sources used are verifiable and accurate, as well as methods for the program 110 to analyze data usage relative to the task being performed and specific attributes of the end user. The ultimate goal is to improve the breadth and depth of data being used in medical practice, while providing an automation and integration of disparate data sources.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A computer-implemented method of recording and tracking medical data, comprising:
saving data in a data hierarchy, including major data categories, in a database;
wherein said data includes primary data, representing various medical disciplines, including all current and historical medical diagnoses and other data on a patient;
retrieving and analyzing medical data from said database, using a processor, in a data search in response to a search query, said medical data being specific to one of said medical disciplines related to one of said major data categories on said patient; and
displaying said medical data on said patient on a display for user review in accordance with said user's electronic profile and preferences.

2. The method of claim 1, wherein history and physical data is a primary data category, and one of sub-categories or all relevant data under said history and physical primary data category, can be retrieved from said database.

3. The method of claim 1, further comprising:
saving results of each search query in said database.

4. The method of claim 1, further comprising:
incorporating results of said data search from each said search query, using said processor, into a future data search protocols to provide pre-populated data search protocols to said user.

5. The method of claim 4, wherein said data search protocols can be modified.

6. The method of claim 4, further comprising:
importing data search protocols between users, using said processor.

7. The method of claim 6, further comprising:
utilizing artificial intelligence inferencing, using said processor, to determine additional data elements to include in each said data search.

8. The method of claim 7, further comprising:
integrating electronic data tracking tools using said processor, into said data search, to monitor and analyze methods of accessing, viewing, and acting upon said data; and
utilizing statistical methods and artificial intelligence techniques, using said processor, to identify similarities for predicting future use.

9. The method of claim 8, wherein said electronic data tracking tools include electronic auditing tools and/or eye tracking software.

10. The method of claim 9, further comprising:
creating automated data presentation and workflow templates, using said processor, based upon analysis of results of said electronic tracking tools.

11. The method of claim 8, further comprising:
prioritizing or ignoring data for saving in said database, using said processor, and/or identifying priority or actionable data for including in said database.

12. The method of claim 11, further comprising:
utilizing data triggers, using said processor, to search, characterize, and select priority or actionable data for inclusion in said database;
wherein said data triggers include at least one of clinical significance, follow-up recommendations, quality assurance events, temporal change, medical or surgical intervention, critical results communication, medical referral or consultation, hospitalization or medical transfer, new or altered medical diagnosis, new or altered medical treatment, or a custom data trigger predetermined by an institutional or individual service provider.

13. The method of claim 11, further comprising:
verifying data using a secondary party, using said processor, before inclusion of said data in said database.

14. The method of claim 13, further comprising:
determining an accuracy of said data being utilized from said data search, using said processor, by validating, refuting, or modifying said data, to provide quality assurance on said data; and
recording at least one of an identity of said source of said data, an editing source, supporting data, or date/time of data transaction, in said database.

15. The method of claim 14, further comprising:
categorizing, using said processor, a quality assurance deficiency with said data and any actions taken; and
providing an automated feedback function, using said processor, to notify said source of said data when said data has said quality assurance deficiency, and to provide said source with results of further data analysis.

16. The method of claim 15, further comprising:
performing data analytics, using said processor, to provide users with statistical data regarding a relative reliability and accuracy of various data sources, to determine which sources are to be used in an automated data search.

17. The method of claim 1, further comprising:
implementing data sensitivity filters, using said processor, such that a desired level of data granularity is achieved in said data search.

18. The method of claim 1, further comprising:
automatically retrieving from said database, and reviewing, using said processor, data search and presentation templates of other users.

19. A non-transitory computer-readable medium containing executable code for recording and tracking medical data, comprising:
saving data in a data hierarchy, including major data categories, in a database;
wherein said data includes primary data, representing various medical disciplines, including all current and historical medical diagnoses and other data on a patient;
retrieving and analyzing medical data from said database, using a processor, in a data search in response to a search query, said medical data being specific to one of said medical disciplines related to one of said major data categories on said patient; and
displaying said patient data on a display for user review in accordance with said user's electronic profile and preferences.

20. A computer system which records and tracks medical data, comprising:
at least one memory which contains at least one program which comprises the steps of:
saving data in a data hierarchy, including major data categories, in a database;
wherein said data includes primary data, representing various medical disciplines, including all current and historical medical diagnoses and other data on a patient;
retrieving and analyzing medical data from said database, using a processor, in a data search in response to a search query, said medical data being specific to one of said medical disciplines related to one of said major data categories on said patient; and
displaying said patient data on a display for user review in accordance with said user's electronic profile and preferences; and
at least one processor for executing the program.
